(19) United States
(12) Patent Application Publication
(10) Pub. No.: US 2024/0039676 A1
(43) Pub. Date: Feb. 1, 2024

(54) SYSTEMS AND METHODS FOR SUBBAND FULL-DUPLEX

(71) Applicant: Samsung Electronics Co., Ltd., Suwon-si (KR)

(72) Inventors: Mohamed Mokhtar Gaber Moursi AWADIN, San Diego, CA (US); Jung Hyun BAE, San Diego, CA (US)

(21) Appl. No.: 18/339,217

(22) Filed: Jun. 21, 2023

Related U.S. Application Data
(60) Provisional application No. 63/359,579, filed on Jul. 8, 2022.
(60) Provisional application No. 63/455,227, filed on Mar. 28, 2023.
(60) Provisional application No. 63/457,743, filed on Apr. 6, 2023.

(51) Int. Cl. H04L 5/00; H04L 5/14

(52) U.S. Cl. CPC H04L 5/0057; H04L 5/14

(57) ABSTRACT

A system and a method are disclosed for subband full-duplex. In some embodiments, a method includes: conducting a measurement, by a User Equipment (UE), using a CSI resource, the CSI resource being a Channel State Information reference signal (CSI-RS) or a Channel State Information Interference Measurement (CSI-IM); and performing channel estimation or beam measurement, by the UE, the channel estimation or beam measurement being based on a set of resources of the CSI resource, the resources of the set of resources being non-contiguous in a symbol of the CSI resource.

### CROSS-REFERENCE TO RELATED APPLICATION

This application claims the priority benefit under 35 U.S.C. § 119(e) of U.S. Provisional Application No. 63/359,579, filed on Jul. 8, 2022, U.S. Provisional Application No. 63/455,227, filed on Mar. 28, 2023, and U.S. Provisional Application No. 63/457,743, filed on Apr. 6, 2023, the disclosure of each of which is incorporated by reference in its entirety as if fully set forth herein.

### TECHNICAL FIELD

The disclosure generally relates to wireless networking. More particularly, the subject matter disclosed herein relates to improvements to wireless networking with subband full-duplex.

### SUMMARY

In a wireless networking system, a User Equipment (UE) may interact with a network node (gNB). The UE may transmit data to the network node and receive data from the network node. In some circumstances, data rates are lower than ideal.

To solve this problem full-duplex communications may be employed. One issue with the above approach is that downlink transmissions from one gNB may interfere with uplink transmissions being received by another gNB. Another issue with the above approach is that certain reference signals (e.g., a Channel State Information reference signal (CSI-RS)) or channels (e.g., a Physical Downlink Control Channel) may overlap with an uplink transmission from a UE participating in full-duplex subband communications.

To overcome these issues, systems and methods are described herein for characterizing and mitigating interference, and for using the portions of a CSI-RS that do not overlap with a full-duplex subband. The above approaches improve on previous methods because they enable improved operation in the presence of full-duplex subband transmissions.

According to an embodiment of the present disclosure, there is provided a method, including: conducting a measurement, by a User Equipment (UE), using a CSI resource, the CSI resource being a Channel State Information reference signal (CSI-RS) or a Channel State Information Interference Measurement (CSI-IM); and performing channel estimation or beam measurement, by the UE, the channel estimation or beam measurement being based on a set of resources of the CSI resource, the resources of the set of resources being non-contiguous in a symbol of the CSI resource.

In some embodiments, the performing of channel estimation or beam measurement, by the UE, includes selecting the set of resources based on resources allocated for full-duplex uplink subband.

In some embodiments: a first portion of a resource block set (RB set) of the CSI resource overlaps one or more resource elements allocated for full-duplex uplink subband; a second portion of the RB set does not overlap any resource elements allocated for full-duplex uplink subband; and the set of resources does not include any resources of the RB set.

In some embodiments: a first portion of a resource block set (RB set) of the CSI resource overlaps one or more resource elements allocated for full-duplex uplink subband; a second portion of the RB set does not overlap any resource elements allocated for full-duplex uplink subband; and the set of resources includes the second portion of the RB set, and does not include the first portion of the RB set.

In some embodiments: a first portion of a CSI subband of the CSI resource overlaps one or more resource elements allocated for full-duplex uplink subband; a second portion of the CSI subband of the CSI resource does not overlap any resource elements allocated for full-duplex uplink subband; and the CSI subband of the CSI resource excludes the first portion of the CSI subband of the CSI resource and consists of only the second portion.

In some embodiments, the UE expects that for each indicated CSI subband to be reported, the CSI-RS linked to the report is at least mapped to the resource blocks (RBs) spanned by the CSI subband.

In some embodiments: the set of resources includes a first portion and a second portion, the second portion being non-contiguous with the first portion; and the method further includes receiving, by the UE, configuration information from a network node (gNB) identifying the first portion of the set of resources and the second portion of the set of resources.

In some embodiments: the set of resources includes a first portion and a second portion, the second portion being non-contiguous with the first portion; and the method further includes determining, by the UE, the first portion of the set of resources and the second portion of the set of resources.

In some embodiments: the set of resources includes a first portion and a second portion, the second portion being non-contiguous with the first portion; and the minimum number of allocated resource elements of the non-contiguous set of resources of the CSI resource in each portion is expected to be greater than a certain threshold.

According to an embodiment of the present disclosure, there is provided a method, including: generating, by a User Equipment (UE), a first Channel State Information (CSI) report based on a first plurality of CSI resources, each of the first plurality of CSI resources being a Channel State Information reference signal (CSI-RS) or a Channel State Information Interference Measurement (CSI-IM); and generating, by the UE, a second CSI report based on a second plurality of CSI resources, each of the second plurality of CSI resources being a Channel State Information reference signal (CSI-RS) or a Channel State Information Interference Measurement (C SLIM), the second plurality of CSI resources being selected based on: instructions from a network node (gNB) or an overlap, in time, of a full-duplex uplink subband with each of the CSI resources of the second plurality of CSI resources, or a change in a network antenna pattern or power pattern between transmission of the first plurality of CSI resources and transmission of the second plurality of CSI resources.

In some embodiments, the method further includes receiving, by the UE, instructions from the network node, the instructions including an identification of a CSI resource of the first plurality of CSI resources or an identification of a CSI resource of the second plurality of CSI resources.

In some embodiments, the method further includes receiving, by the UE, the identification in the form of a Radio Resource Control (RRC) parameter or a MAC-CE.

In some embodiments, the second CSI report is a differential report with respect to the first CSI report.

In some embodiments: the generating of the first CSI report includes generating the first CSI report based on a first power offset; and the generating of the second CSI report includes generating the second CSI report based on a second power offset, different from the first power offset.

In some embodiments, the method further includes receiving, by the UE, from a network node (gNB) the first power offset or the second power offset as part of Radio Resource Control (RRC) configuration information.

In some embodiments, the method further includes: receiving, by the UE, from the gNB, a third power offset as part of Radio Resource Control (RRC) configuration information; and using the first power offset or the second power offset to override or to modify, by the UE, the third power offset.

In some embodiments: the first CSI report is based on a first plurality of subcarriers within each the first plurality of CSI resources; and the second CSI report is based on a second plurality of subcarriers, different from the first plurality of subcarriers, within each the second plurality of CSI resources.

According to an embodiment of the present disclosure, there is provided a method, including: receiving, by a User Equipment (UE), configuration information including a Control Resource Set (CORESET) and a first monitoring occasion; and determining, by the UE, that in the first monitoring occasion, the CORESET overlaps a resource element (RE) allocated for a full-duplex uplink subband.

In some embodiments, the method further includes excluding from the CORESET, by the UE, each resource block of the CORESET overlapping a resource element (RE) allocated for a full-duplex uplink subband.

In some embodiments, the method further includes not monitoring, by the UE, a Physical Downlink Control Channel (PDCCH) candidate overlapping a resource element allocated for the full-duplex uplink subband.

### BRIEF DESCRIPTION OF THE DRAWINGS

In the following section, the aspects of the subject matter disclosed herein will be described with reference to exemplary embodiments illustrated in the figures, in which:

FIG. 1 is a resource allocation drawing, according to an embodiment;

FIG. 2 is a resource allocation drawing, according to an embodiment;

FIG. 3 is a resource allocation drawing, according to an embodiment;

FIG. 4 is a resource allocation drawing, according to an embodiment;

FIG. 5 is a resource allocation drawing, according to an embodiment;

FIG. 6 is a subband map, according to an embodiment;

FIG. 7 is a subband map, according to an embodiment;

FIG. 8 is a resource allocation drawing, according to an embodiment;

FIG. 9 is an illustration of the structure of a Media Access Control Control Element (MAC CE), according to an embodiment;

FIG. 10 is a resource allocation drawing, according to an embodiment;

FIG. 11 is a resource allocation drawing, according to an embodiment;

FIG. 12 is an illustration of a measurement procedure, according to an embodiment;

FIG. 13 is a set of resource allocation drawings, according to an embodiment;

FIG. 14 is a set of resource allocation drawings, according to an embodiment;

FIG. 15 is a set of resource allocation drawings, according to an embodiment;

FIG. 16 is a set of resource allocation drawings, according to an embodiment;

FIG. 17 is a resource allocation drawing, according to an embodiment;

FIG. 18A is a flowchart, according to an embodiment;

FIG. 18B is a flowchart, according to an embodiment; and

FIG. 19 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments.

Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. As used herein, the term “or” should be interpreted as “and/or”, such that, for example, “A or B” means any one of “A” or “B” or “A and B”.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

To provide the user equipment (UE) with the configuration parameters of channel state information-reference signal (CSI-RS), the next generation NodeB (gNB) uses nested radio resource control (RRC) information elements (IEs) and some other portions of the configurations is provided based on the activation or triggering method. Specifically, CSI-ResourceConfig IE contains, but is not limited to, a list of NZP-CSI-RS-ResourceSet, CSI-SSB-ResourceSet and CSI-IM-ResourceSet and the corresponding time domain behavior of the resources within these lists in terms of periodic, semi-persistent and periodic behaviors. The NZP-CSI-RS-ResourceSet contains, but is not limited to, a list of NZP-CSI-RS-Resource and an indication whether the UE can assume that all NZP-CSI-RS-Resource within the set are transmitted using the same downlink (DL) beam, i.e., whether repetition is “on”. For aperiodic CSI-RS, an offset of X slots is configured between the downlink control information (DCI) triggering a set of aperiodic non-zero power (NZP) CSI-RS resources and the slot in which the CSI-RS resource set is transmitted, i.e., the RRC parameter aperiodicTriggeringOffset is used to configure such an offset. As used herein, both the singular and plural form of channel state information-reference signal may be abbreviated “CSI-RS”, i.e., CSI-RS may be short for channel state information-reference signal or for channel state information-reference signals. Channel state information-reference signals may also be abbreviated “CSI-RSs”.

The NZP-CSI-RS-Resource provides the time domain and frequency domain location. Regarding the frequency domain allocation of NZP-CSI-RS, for the determination of resource blocks (RBs) spanned by CSI-RS, the starting position and number of the RBs in which the UE shall assume that CSI-RS is transmitted are given by the higher-layer parameters freqBand in the CSI-RS-ResourceMapping IE for the DL bandwidth part (BWP) given by BWP-Id in the CSI-ResourceConfig IE. Both nrofRBs and startingRB in CSI-FrequencyOccupation are configured as integer multiples of 4 RBs, and the reference point for startingRB is common resource block (CRB) 0 on the common resource block grid. If startingRB<N_{BWP}^{start}, the UE shall assume that the initial CRB index of the CSI-RS resource is N_{initialRB}=N_{BWP}^{start}, otherwise N_{initial RB}=startingRB. If nrof RBs>N_{BWP}^{size}+N_{BWP}^{start}−N_{initial RB}, the UE shall assume that the bandwidth of the CSI-RS resource is N_{CSI-RS}^{BW}=N_{BWP}^{size}+N_{BWP}^{start}−N_{initial RB}, otherwise N_{CSI-RS}^{BW}=nrofRBs. In all cases, the UE shall expect that N_{CSI-RS}^{BW}≥min (24, N_{BWP}^{size}).

The frequency domain allocation of channel state information-interference measurement (CSI-IM) resources in terms of the allocated RBs follows the same approach as regular NZP-CSI-RSs and the same CSI-FrequencyOccupation IE used for this purpose. More details can be found in 3GPP TS 38.214: “Physical layer procedures for data”, Rel. 17, V17.1.0, and in 3GPP TS 38.331: “Radio Resource Control (RRC) protocol specification”, Rel. 17, V17.0.0.

Subband/wideband reporting may be performed as follows. The gNB may configure the UE to report channel quality indicator (CQI)/precoding matrix indicator (PMI) for either wideband or subband. The RRC parameters cqi-FormatIndicator/pmi-FormatIndicator in the CSI-ReportConfig IE is used to indicate which reporting mode should be applied. If it is set to widebandCQI/widebandPMI, the UE provides a single CQI/PMI report based on the measurements of CSI-RS allocated in the DL BWP. On the other hand, if it is set to subbandCQI/subbandPMI, the UE provides multiple CQI/PMI reports based on the measurements from the corresponding BWP.

To determine the subband size, the gNB may indicate the CSI subband size by RRC parameter subbandSize that may be set to value1 or value2 to determine the CSI subband size based on the size of the BWP according to Table 2. The CSI subbands are defined relative to the CRB. Therefore, the first and last CSI subband may be a partial subband depending on the start and size of the associated BWP. Table 1 shows the configurable subband sizes.

TABLE 1

| Bandwidth part (PRBs) | Subband size (PRBs) |
|---|---|
| 24-72 | 4, 8 |
| 73-144 | 8, 16 |
| 145-275 | 16, 32 |

To indicate which subbands are to be included in the report, the RRC parameter csi-ReportingBand carries a bitmap indicating which contiguous or non-contiguous subset of subbands are in the BWP. The right-most bit in the bit string represents the lowest subband in the BWP. More details can be found in 3GPP TS 38.214: “Physical layer procedures for data”, Rel. 17, V17.1.0, and in 3GPP TS 38.331: “Radio Resource Control (RRC) protocol specification”, Rel. 17, V17.0.0.

Enhanced interference mitigation and traffic adaptation (eIMTA) may be performed as follows. In Long Term Evolution (LTE), enhanced interference mitigation and traffic adaptation (eIMTA) was introduced in LTE Rel-12 to support dynamic reconfigurations of uplink (UL)/DL subframes. In earlier LTE releases, the time division duplexing (TDD) frame configurations is indicated in system information block 1 (SIB1) by selecting one of a set of permitted configurations (identified in TS 36.211 promulgated by the 3rd Generation Partnership Project (3GPP)). From LTE Rel-12 onwards, eIMTA allows dynamic TDD configurations by introducing the following definitions. (i) The uplink reference configuration is obtained from SIB1. It is also the configuration used by non-eIMTA-capable devices, simply known as the uplinkedownlink configuration in earlier releases. Downlink subframes in this reference configuration are guaranteed to be downlink subframes despite any dynamic reconfiguration. (ii) The downlink reference configuration is obtained from dedicated RRC signaling, specific to eIMTA-capable devices. Uplink subframes in this reference configuration are guaranteed to be uplink subframes despite any dynamic reconfiguration. (iii) The current uplink-downlink configuration determines which subframes are uplink and which are downlink in the current frame. It must be chosen among the seven possible uplink-downlink allocations and be within the limits set by the flexible subframes obtained from the reference configurations.

The current uplink-downlink allocation is broadcasted using DCI format 1C on the physical downlink control channel (PDCCH) to all eIMTA-enabled devices. A special identity, the eIMTA-radio network temporary identifier (RNTI), is used on the control channel to indicate the current configuration. Multiple three-bit fields are used in DCI format 1C, each field indicating one of the seven uplink-downlink configurations for each of the component carriers the device is configured with, subject to any restrictions arising from the reference configurations. In terms of configurations:
(i) eimta-CommandPeriodicity configures the periodicity to monitor PDCCH with eIMTA-RNTI. Values sf10, sf20, sf40 and sf80 correspond to 10, 20, 40 and 80 ms subframes, respectively.
(ii) eimta-CommandSubframeSet configures the subframe(s) to monitor PDCCH with eIMTA-RNTI within the periodicity configured by eimta-CommandPeriodicity. The 10 bits correspond to all subframes in the last radio frame within each periodicity. In case of TDD as primary cell (PCell), only the downlink subframes indicated by the DL/UL subframe configuration in SIB1 (in the uplink reference configuration) may be configured for monitoring PDCCH with eIMTA-RNTI. In case of frequency domain duplexing (FDD) as PCell, any of the ten subframes may be configured for monitoring PDCCH with eIMTA-RNTI.

Upon detecting the DCI format 1C using the eIMTA-RNTI, the device will set the current uplink-downlink configuration accordingly. However, a device may occasionally not succeed in receiving the current uplink-downlink allocation and thus may not know which subframes are uplink and which are downlink. In this situation, the device behaves in the same way as a non-eIMTA-enabled device.

The impact of dynamic TDD on other procedures in LTE may be described as follows. For measurement, the transmission direction of subframes is not necessarily aligned across multiple cells. Consequently, the interference scenario may be substantially different between subframes guaranteed to be downlink and subframes that are flexibly assigned to downlink. This will impact not only measurements for radio-resource management, for example, handover decisions, but also rate control. Handover decisions should be consistent and not be influenced by short-term traffic variations. Therefore, measurements such as reference signal received power (RSRP) and reference signal received quality (RSRQ) used for mobility handling are made upon guaranteed downlink subframes and not impacted by changes in the current uplink/downlink configuration. Rate control should reflect the instantaneous channel conditions at the device. Since the interference behavior may be quite different between guaranteed and flexible downlink subframes, interference is measured separately for the two sets of subframes, and CSI reports are provided separately for each of the two sets.

More details may be found in TS 36.211 promulgated by the 3rd Generation Partnership Project (3GPP).

Enhanced inter-cell interference coordination (eICIC) may be performed as follows. To address the interference scenario in heterogeneous deployment, enhanced inter-cell interference coordination (eICIC) was developed in LTE Rel-10. The key enhancement in eICIC is to define a set of subframes in which the macro cell may reduce its transmit power such that the UEs that are served by pico cell experience less interference. This set of subframes is known as almost blank subframes (ABS). Therefore, the UEs that are served by the pico cell, close to the edge of the pico cell or even in the range expansion area, may be served in the ABS. The UEs that are served by the pico cell and close to its center may be served in all subframes. At the same time, the macro cell attempts to avoid scheduling its UEs in ABS.

The reason for calling this set of subframes an ABS is that the macro cell still needs to transmit some signals/channels to enable the UE to conduct measurements, such as transmitting common reference signal (CRS), primary synchronization signal (PSS), secondary synchronization signal (SSS), and physical broadcast channel (PBCH). Also, to minimize the impact on UL scheduling, the macro cell still transmits physical channel hybrid ARQ indicator channel (PHICH) in the ABS.

The interference experienced by the UE served by the pico cell depends on whether measurements are conducted in ABS or non-ABS. To address this issue the UE is provided with information about ABS (bitmaps). Specifically, the two bitmaps are provided to the UEs served by the pico cell, one defines the set of ABS and another one defines the set of highly interfered subframes. The remaining subframes, if any, not belonging to either of these two subsets have unpredictable interference situations because the macro may or may not use reduced power. Each bit map has 40 bits where each bit corresponds to a particular subframe and then the bitmap is repeated in case of FDD.

CSI is measured over each set separately. The UE should only average interference during subframes belonging to the same subset. This is beneficial to provide the base station with accurate channel status. It is mandated that any given subframe should only belong to one subset but not to both. Also, the UE is not expected to perform CSI measurements in a subframe that doesn't belong to either subframe set. More details may be found in E. Dahlman, S. Parkvall, and J. Skold, “4G, LTE-advanced Pro and the Road to 5G” Academic Press, 3rd edition, 2016.

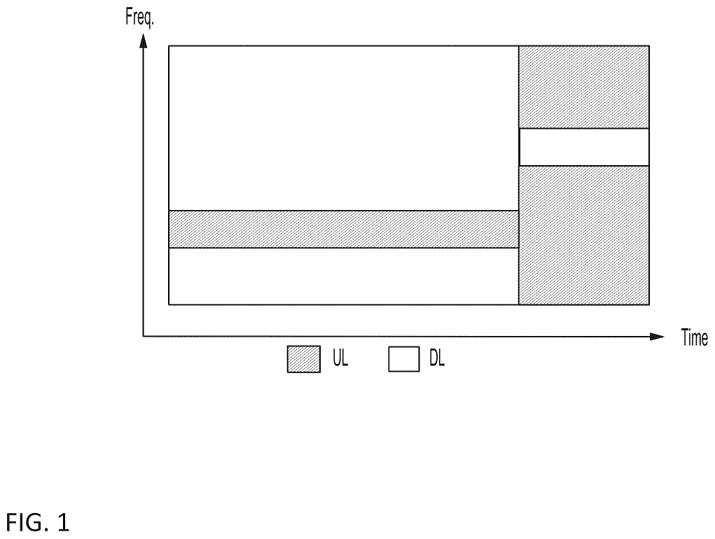

One approach to realize the benefits of full-duplex operation mode, while maintaining reasonable implementation overhead, is to use a subband non-overlapping scheme. In this scheme a portion of the time-frequency resources are used for DL/UL, while the remaining time-frequency resources are used for UL/DL, respectively, as exemplified in FIG. 1.

The legacy design of different reference signals, such as CSI-RS, sounding reference signal (SRS), etc., is not optimized for the non-contiguous frequency domain resources due to the presence of UL/DL subbands. For instance, the CSI-RS is allocated contiguously in the frequency domain and is defined relative to the CRB by indicating the starting PRB and the number of PRBs.

In addition, for different CSI report quantities such as CQI, PMI, rank indicator (RI), L1-RSRP, L1-signal to interference plus noise ratio (SINR), the UE may average across multiple reference signals to generate the required report quantities. In this case, it is important that the averaged reference signals experience the same channel condition to avoid corrupting the reported measurements. For example, a CSI-RS that is transmitted from a particular gNB and overlaps with the UL subband of other gNB cannot be averaged with CSI-RS that does not overlap with an UL subband because they experience different interference situations. Therefore, it may be advantageous to address this issue to guarantee averaging across the proper reference signals.

Another aspect of operation in the presence of UL/DL subbands is how to handle gNB-to-gNB cross link interference (CLI). Specifically, it may be beneficial to have procedures to enable measuring the CLI from one gNB to another such that appropriate actions may be taken. Among those possible actions is how Tx/Rx beams may be coordinated among different gNBs to reduce CLI. Furthermore, UE-to-UE CLI may be addressed. This includes how CLI among different UEs may be measured and reported. In legacy UE-to-UE CLI based on SRS measurements, it is up to the UE implementation to determine which receive beam should be used for the reception of SRS for CLI.

This disclosure describes the following features.
1. Procedures to enhance channel and interference measurements which include the following
   a. Enhancements to the reference signals and subband CSI reporting to handle the cases when they collide with UL subband in frequency domain.
      i. Redefine CSI-RS/CSI-IM resource/CSI-subband to be truncated by UL subband, or to be defined below and above the UL subband.
      ii. Define which portion of CSI-RS/CSI-IM resource/CSI-subband to be measured or reported based on the number of allocated RBs.
   b. Approaches to determine whether or not the reference signals collide with UL subband.
      i. Define different reporting types (clean and dirty) to accurately measure the channel quality and report it to the gNB.
      ii. Several methods to indicate how the reference signals can be classified as clean or dirty (RRC, medium access control-control element (MAC-CE) or DCI) and generate the associated reports.
      iii. Introduce frequency domain restriction to indicate which set of RBs should not be used to derive the channel/interference measurements
2. Algorithms to enable gNB-to-gNB CLI measurements which includes
   a. Defining the reference signals and the corresponding configurations to be used for this purpose, e.g., CSI-RS.
   b. Enable reporting to indicate which beams from the aggressor gNB that cause the least interference.
   c. UE-assistance to mitigate gNB-to-gNB CLI
      i. Enable the UE to rate match/puncture the UL transmission around to enable the victim gNB to measure the interference from the aggressor gNB.
      ii. Enable the victim/aggressor gNB to configure their UEs with different beams for semi-persistent scheduling (SPS) physical downlink shared channel (PDSCH) or configured grant (CG) physical uplink shared channel (PUSCH) to reduce the interference impacts.
3. Solutions to enable UE-to-UE CLI which includes
   a. The aggressor UE can cancel its UL transmission when it causes high interference to the victim UE.
   b. The aggressor UE can reduce the power its UL transmission when it causes high interference to the victim UE.
   c. The aggressor UE can change its UL transmission beam when the original one causes high interference to the victim UE.
4. Enhancements for the CORESET when it collides with the UL subband which include the following:
a. The UE is not required to monitor the PDCCH candidate when it collides with the UL subband.
b. If downlink is allowed in the UL subband, the UE monitors the PDCCH candidate even if it collides with UL subband.
c. The UE may assume that some search spaces may be protected from collision with UL subband such as Type0-PDCCH CSS.
d. The RBs belonging to the CORESET remain unchanged for at least a particular duration, e.g., the periodicity of the search space, indicated via capability signaling.
e. The UE may indicate to the gNB whether it supports handling the case in which the RBs belonging to CORESET associated with a search space change due to collision with UL subband.

The solutions described in this disclosure apply equally for nodes, e.g., gNB or UE, operating in subband full-duplex mode or in flexible/dynamic TDD. Moreover, when the gNB deploys network energy saving (NES) procedures such as spatial domain adaptation or power domain adaptation, the described solutions in this disclosure can be applied. The reason is that in both full-duplex and NES operations, the gNB may need to adjust its transmission and reception panels by enabling/disabling all or subset of antenna elements associated to a logical antenna port or by using different transmit power. In full-duplex operation, the gNB may need the spatial domain adaptation or power domain adaptation to reduce the self-interference to reasonable level. In NES operation, the gNB may use the spatial domain adaptation or power domain adaptation to reduce the power consumption.

In some embodiments, frequency domain and time domain enhancements are made for reference signals and channel/interference measurements, and CORESET handling may be enhanced. Frequency domain enhancements may include enhancements to measurement reference signals and to subband reporting.

Enhancements to measurement reference signals may include the following. Though the solutions developed in this disclosure are described for NZP-CSI-RS/CSI-RS, they are equally applicable to CSI-IM resources as well. That is, the frequency allocation procedure across different RBs is the same for NZP-CSI-RS and for CSI-IM resources.

In legacy NR, for the determination of RBs spanned by CSI-RS, the starting position and number of the RBs in which the UE shall assume that CSI-RS is transmitted are given by the higher-layer parameters freqBand in the CSI-RS-ResourceMapping IE for the DL BWP given by BWP-Id in the CSI-ResourceConfig IE. Both nrofRBs and startingRB in CSI-FrequencyOccupation are configured as integer multiples of 4 RBs, and the reference point for startingRB is CRB 0 on the common resource block grid. If startingRB<N_{BWP}^{start}, the UE shall assume that the initial CRB index of the CSI-RS resource is N_{initial RB}=N_{RBW}^{start}, otherwise N_{initial RB}=startingRB. If nrof RBs>N_{BWP}^{size}+N_{BWP}^{start}−N_{initial RB}, the UE shall assume that the bandwidth of the CSI-RS resource is N_{CSI-RS}^{BW}=N_{BWP}^{size}+N_{BWP}^{start}−N_{initial RB}, otherwise N_{CSI-RS}^{BW}=nrofRBs. In all cases, the UE shall expect that N_{CSI-RS}≥min (24, N_{BWP}^{size}).

To define CSI-RS below and above the UL subband, the gNB may provide the UE with the frequency domain location of CSI-RS by indication of its two locations, one below the UL subband and another one above UL subband. For example, the legacy RRC parameter freqBand in CSI-RS-ResourceMapping IE may be used to define the frequency domain location below the UL subband. A new parameter may be introduced to define the frequency domain location above the UL subband, e.g., RRC parameter freqBand_above.

Alternatively, when an UL subband is present, the UE assumption regarding RBs occupied by CSI-RS may be clarified. As one possibility, the CSI-RS may be carried by RBs that do not overlap with the UL subband.

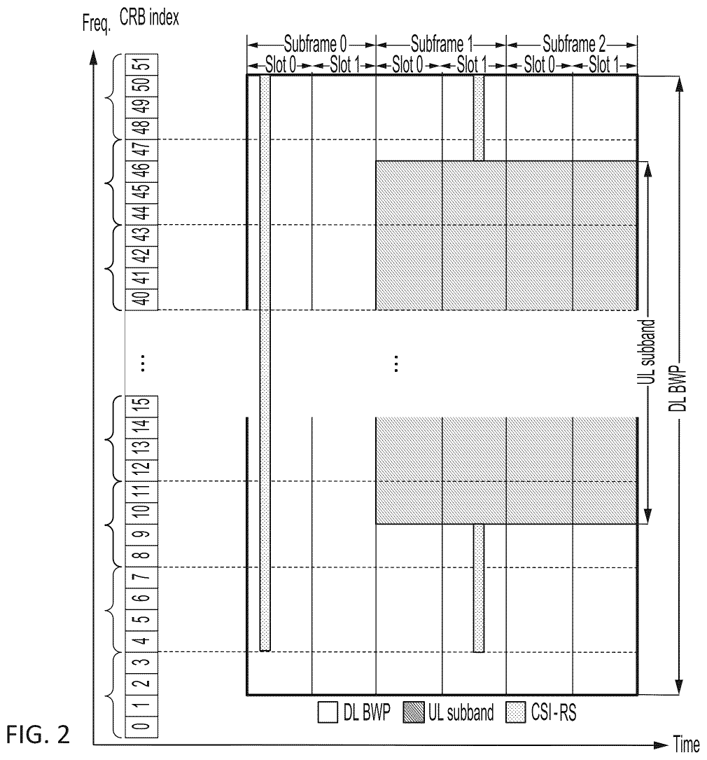

FIG. 2 shows an example of the CRB grid and DL BWP that overlaps with an UL subband. This UL subband may be configured to the same UE receiving CSI-RS (full-duplex UE), or to other UE(s) different from the UE receiving CSI-RS (half duplex UE). The startingRB is set to CRB 4 and nrofRBs is set to 47. When the CSI-RS instance does not overlap with the UL subband, the UE may assume that the CSI-RS instance occupies the RBs based on legacy configurations, e.g., a CSI-RS instance in Slot 0. When CSI-RS the instance overlaps with the UL subband, only RBs outside the UL subband may be used for the transmission of the CSI-RS instance. The resulting RBs carrying the CSI-RS instance are not necessarily constructed as sets of 4 contiguous RBs. This is depicted in FIG. 2 where CRBs 10-46 do not carry CSI-RS. In other words, nrofRBs may be interpreted relative to the DL BWP similar to legacy NR. However, the RBs indicated to belong to CSI-RS and confined within the present UL subband are excluded from CSI-RS.

Also, regardless of whether or not CSI-RS overlaps with UL subband, the UE may assume that CSI-RS occupies the same RBs as if UL subband is present. This may be beneficial because in such an embodiment, the CSI-RS occupies the same set of RBs all the time and the UE does not need to deal with two different sets of RBs.

Alternatively, nrofRBs may be interpreted relative to only RBs that do not overlap with UL subband when it is present. When the allocated RBs for CSI-RS exceed the DL BWP boundaries, the UE may assume that those RBs are truncated and are not used for CSI-RS.

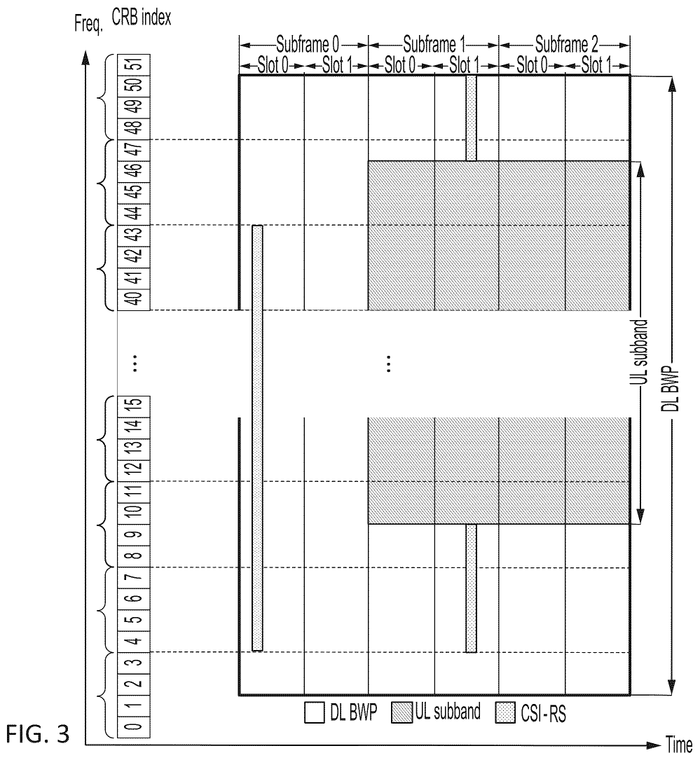

FIG. 3 shows an example in which startingRB is set to CRB 4, and the nrofRBs is set to 40, and these values are used regardless of whether the CSI-RS instance overlaps with the UL subband. The CSI-RS instance location in the frequency domain varies based on whether or not the CSI-RS instance overlaps with the UL subband. When the CSI-RS instance does not overlap with the UL subband, it starts from CRB 4 and ends at CRB 43. On the other hand, when the CSI-RS instance overlaps with the UL subband, only RBs that do not overlap with the UL subband are counted. When the CSI-RS instance reaches the upper BWP boundaries, the remaining RBs are truncated in a manner similar to that of legacy NR.

A legacy UE can handle two exceptions regarding the RBs allocated to CSI-RS not constructing a set of contiguous RBs at the edges of the DL BWP. Specifically, all the allocated RBs for CSI-RS should be a set of physically contiguous 4 RBs except the first and last ones depending on their locations relative to DL BWP boundaries. It may be beneficial not to increase the number of exceptions that the UE is supposed to handle.

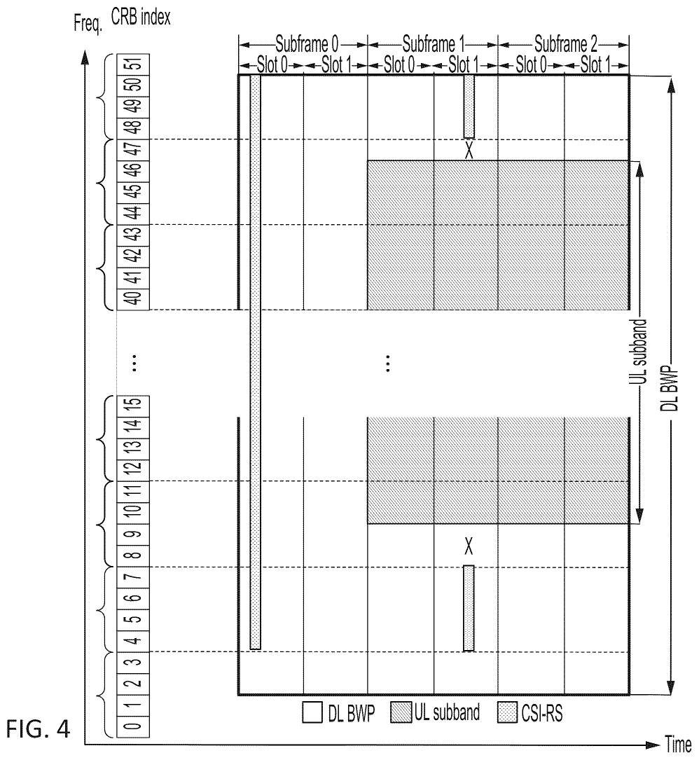

As one possibility, only two legacy exceptions may be applied for RBs carrying CSI-RS not constructing a set of 4 RBs at the boundaries of the DL BWP. If the UL subband partially overlaps with any set of 4 RBs for CSI-RS, the whole set of 4 RBs is not used for CSI-RS. FIG. 4 shows an example in which only integer multiples of 4 RBs are used for CSI-RS except the last set of RBs which has 3 RBs due to crossing the DL BWP boundary. As in the solution described in FIG. 2, for the set that includes the CRB {8, 9, 10, 11}, the UL subband overlaps with only CRB {10, 11}; however, in the embodiment of FIG. 4, the whole set of CRB {8, 9, 10, 11} is unused in the CSI-RS. The same applies for the CRB set {44, 45, 46, 47} which partially overlaps with the UL subband. The symbol “X” illustrates RBs that are no longer occupied by CSI-RS compared to the solution in FIG. 2.

In the embodiment of FIG. 4, when nrofRBs is interpreted relative to all RBs including those in the UL subband, the CSI-RS is transmitted on RBs that are in sets of 4 consecutive RBs, none of the RBs in any such set of 4 overlapping with the UL subband, in addition to the legacy exceptions of CSI-RS at the DL BWP boundaries.

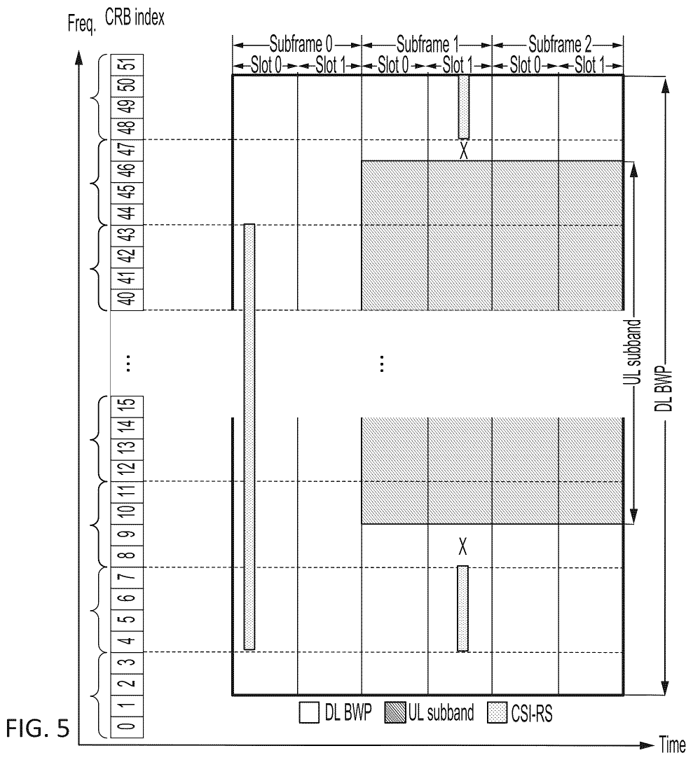

The same idea may be applied to the solution described in FIG. 3, as depicted in FIG. 5. The symbol “X” illustrates RBs that are no longer occupied by CSI-RS compared to the solution in FIG. 3. In the embodiment of FIG. 5, when nrofRBs is interpreted relative to only RBs that do not overlap with the UL subband, CSI-RS is transmitted on RBs that are in sets of 4 consecutive RBs, none of the RBs in any such set of 4 overlapping with the UL subband, in addition to the legacy exceptions of CSI-RS at the DL BWP boundaries.

The UE may indicate to the gNB the number of exceptions that it may handle, e.g., as part of UE capability signaling. For example, if the number of indicated exceptions is two, then the exceptions may occur at the DL BWP boundaries or UL subband such that the total number of exceptions is equal to two. If there are more exceptions to be applied than what the UE indicated, the aforementioned schemes may be applied. To determine where the exceptions are to be applied and where the UE assume CSI-RS is not present, predefined rules, e.g., provided in specs (e.g., in the NR standard), may be applied. For example, the order of applied exceptions may be as follows: lower edge of DL BWP, upper edge of DL BWP, lower edge of UL subband, and upper edge of UL subband.

As yet another possibility, if the CSI-RS instance partially or fully overlaps with the UL subband, the UE may cancel the CSI-RS instance reception in the set of symbols in which the overlap occurs. This is beneficial to avoid having non-contiguous CSI-RS in the frequency domain. Also, the UE may not expect the CSI-RS to overlap with UL subband. Combination of these solutions may be applied for different CSI-RS types. For example, periodic-CSI-RS (P-CSI-RS) or semi-persistent-CSI-RS (SP-CSI-RS) may overlap with the UL subband and in this case the UE cancel their reception in this case. On the other hand, the UE does not expect aperiodic-CSI-RS (AP-CSI-RS) to overlap with UL subband.

Rather than completely canceling the CSI-RS reception in the set of symbols which overlaps with UL subband, the UE may still receive one contiguous portion of the allocated RBs for CSI-RS below or above the UL subband. The portion to be received may be predefined, i.e., provided in the specs, for example the lower portion is always received when the CSI-RS overlaps with UL subband. Moreover, some rules may determine which portion to be received. For example, the portion that has more RBs is received. This is beneficial to ensure that the more RBs are used to derive the measurement which in turns enhance its accuracy.

Moreover, in legacy NR, the UE shall expect that N_{CSI-RS}^{BW}≥min (24, N_{BWP}^{size}) where, if nrofRBs>N_{BWP}^{size}+N_{BWP}^{start}−N_{initial RB}, the UE shall assume that the bandwidth of the CSI-RS resource is N_{CSI-RS}^{BW}=N_{BWP}^{size}+N_{BWP}^{start}−N_{initial RB}, otherwise N_{CSI-RS}^{BW}=nrofRBs. Therefore, with the present of UL subband, such constraint should be revised. As one possibility, the bandwidth of CSI-RS may be defined as the number of RBs below and above the UL subband, e.g., N_{CSI-RS,below}^{BW} and N_{CSI-RS,above}^{BW}, respectively. In this case, the leagcy constrain may be applied on function of both bandwidths of CSI-RS. For example, N_{CSI-RS,below}^{BW}+N_{CSI-RS,above}^{BW}≥min (24, N_{BWP}^{size}), min(N_{CSI-RS,below}^{BW}, N_{CSI-RS,above}^{BW})≥min (24, N_{BWP}^{size}), max(N_{CSI-RS, below}^{BW}, N_{CSI-RS,above}^{BW})≥min (24, N_{BWP}^{size}), N_{CSI-RS, below}^{BW}≥min(24, N_{BWP}^{size}), N_{CSI-RS,above}^{BW}≥min (24, N_{BWP}^{size}) etc. This is beneficial to ensure there is enough RBs allocated for CSI-RS to accurate measurements.

Also, the threshold on the width of CS-RS may be modified to reflect that DL BWP is divided into two parts below and above the UL subband when present. Instead of having the threshold min (24, N_{BWP}^{size}), it may be min (x, N_{BWP}^{size}), where x is indicated by the UE as part of its capability signaling for example, or predefined (provided in the specs). Moreover, separate thresholds may be defined for each portion of CSI-RS below and above the UL subband. For example, N_{CSI-RS, below}^{BW}≥min (24, N_{BWP,below}^{size}), N_{CSI-RS,below}^{BW}≥min (x, N_{BWP,below}^{size}) and N_{CSI-RS,above}^{BW}≥min (24, N_{BWP,above}^{size}), N_{CSI-RS,above}^{BW}≥min (x, N_{BWP,above}^{size}) where N_{BWP,below}^{size} and N_{BWP,above}^{size} are the number of RBs with DL BWP below and above UL subband, respectively. Combination of the aforementioned to determine the minim number of RBs occupied by CSI-RS may be used as well.

To further enhance the gNB scheduling flexibility, nrofRBs or startingRB in CSI-FrequencyOccupation may take any value and not necessary to configured as integer multiples of 4 RBs relative to CRB. This may apply for the case that a single set of parameters used to provide CSI-RS or two sets of parameters used to provide CSI-RS portions below and above the UL subband. This is beneficial because gNB may indicate the start and width of CSI-RS without colliding with UL subband. Alternatively, nrofRBs or startingRB in CSI-FrequencyOccupation may be configured as integer multiples of 4 RBs but additional offset in the frequency domain may be configured. This offset enable CSI-RS to be shifted up or down and avoid colliding with UL subband. Regardless how CSI-RS is indicated or configured to the UE, the density of CSI-RS per RB in all configured subband or at least in the subband indicated to be reported should be the same.

The UE may indicate to the gNB whether or not it supports the reception of non-contiguous CSI-RS due to the presence of UL subband through UE capability signaling for example. In addition, the indicated capability may depend on minimum number of RBs occupied by CSI-RS. For example, if the allocated number of RBs for each portion of CSI-RS (below and above UL subband) is bigger than particular threshold(s) indicated by the UE or predefined, the UE may support non-contiguous reception of CSI-RS. Alternatively, if the allocated number of RBs for at least one portion of CSI-RS (below or above UL subband) is bigger than particular threshold(s) indicated by the UE or predefined, the UE may support non-contiguous reception of CSI-RS. This is beneficial as, for example, the UE may only receive one portion and may still apply the legacy wideband processing for channel estimation on any portions of the CSI-RS that have enough RBs to generate accurate measurements.

Subband reporting may be performed as follows. In legacy NR, for CSI reporting, the gNB may configure the UE to either provide a wideband CSI report or a subband CSI report. In case of a wideband report, the UE reports the indicated quantity based on the measurements of CSI-RS allocated in the DL BWP. On the other hand, for CSI subband reporting, the gNB may indicate the CSI subband size by RRC parameter subbandSize that may be set to value1 or value2 to determine the CSI subband size based on BWP size according to Table 2. The CSI subbands are defined relative to the CRB. Therefore, the first and last CSI subband may be partial subbands depending the start and size of the associated BWP.

TABLE 2
Configurable subband sizes

| Bandwidth part (PRBs) | Subband size (PRBs) |
|---|---|
| 24-72 | 4, 8 |
| 73-144 | 8, 16 |
| 145-275 | 16, 32 |

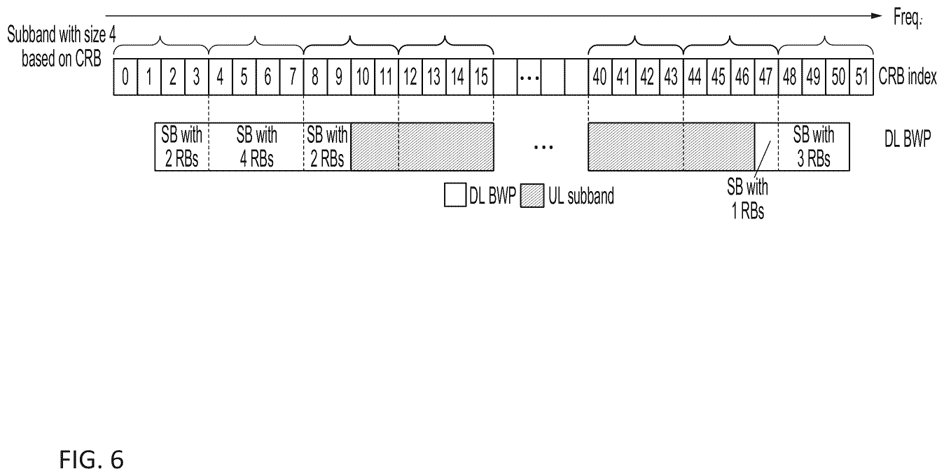

The aforementioned solutions for determining the start and bandwidth of the CSI-RS may be extended to the definition of the CSI reporting subband. FIG. 6 shows an example in which the CSI subbands divided by the UL subband boundaries have a different number of RBs than the remaining subbands when they overlap with the UL subband. The remaining CSI subbands that fully overlap with the UL subband are not reported. However, when a UL subband is not present, those subbands have the normal number of RBs and may be reported in the same way as in legacy NR.

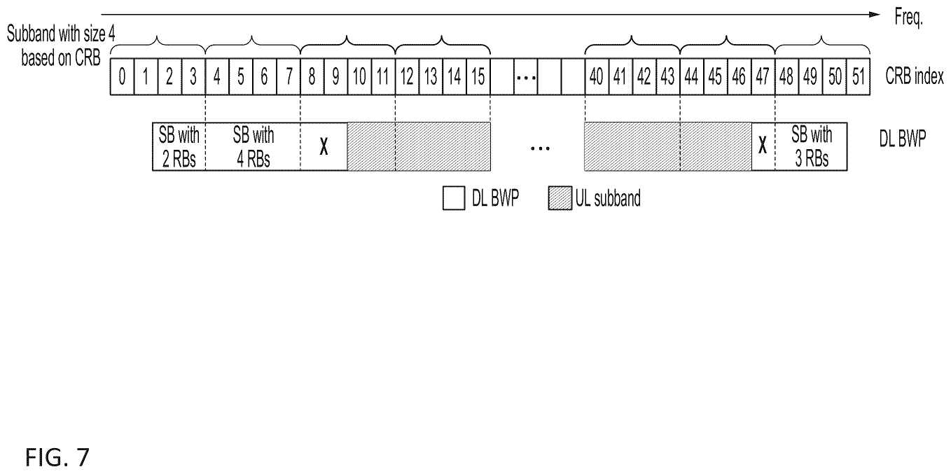

To avoid changing the length of the CSI subbands, other than the first and last subbands, when the CSI subbands partially or fully overlap with a UL subband, the UE does not report them as part of a CSI report, as exemplified in FIG. 7. However, when the UL subband is not present, those subbands have the normal number of RBs and may be reported in the same way as in legacy NR. Moreover, CSI subbands linked to a CSI-RS resource which has the frequency density of each CSI-RS port per PRB in the subbands less than the configured density of the CSI-RS resource are not reported. In other words, for a CSI reporting subband which overlaps with UL subband boundaries, the CSI report is derived based on linked CSI-RS/CSI-IM resources excluding CSI-RS/CSI-IM resources overlapping with the UL subband where the size of this CSI reporting subband may be adjusted to ensure the frequency density condition as described earlier.

As yet another possibility, if any CSI subband partially or fully overlaps with a UL subband, the UE does not report CSI for this occasion. Also, the UE may not expect any of the configured CSI subband to overlap with a UL subband. Combinations of these solutions may be applied for different CSI report types. For example, a CSI subband for P- or SP-CSI reporting may overlap with a UL subband and in this case the UE may cancel reporting the CSI associated with these occasions. On the other hand, the UE does not expect a CSI subband for AP-CSI reporting to overlap with a UL subband.

Rather than completely canceling the CSI reporting when any of the requested CSI subband to be reported partially or fully overlaps with a UL subband, the UE may still report the corresponding measurement for all the configured subbands, except the ones that partially or fully overlap with the UL subband. Alternatively, the UE may report the CSI of indicated contiguous or non-contiguous subbands as long as the CSI-RS or CSI-IM resources associated with the indicated subbands occupy contiguous RBs. This CSI-RS or CSI-IM may be the portion below or above the UL subband. For the determination of which portion of CSI-RS is to be received, and to determine the corresponding CSI subbands to be reported, predefined rules, i.e., provided in the specs, may be applied, e.g., the lower portion may be used. Alternatively, some rules may be applied to determine which portion of CSI-RS is received and to determine the corresponding CSI subbands. For example, the UE may receive the CSI-RS portion that is allocated more RBs and provide the report for the corresponding CSI subbands.

The CSI subband(s) corresponding to a CSI-RS portion may be the contiguous or non-contiguous indicated CSI subband(s) that fully overlap with the received CSI-RS portion. Regarding wideband reporting, when a UL subband is present, wideband reporting of the CSI may be derived based on the available RBs below and above the UL subband. In this case, the UE provides the gNB with a single wideband measurement report. Alternatively, the wideband reporting may become CSI reporting over two CSI-wideband-subbands. The first CSI-wideband-subband may be above the UL subband and second CSI-wideband-subband may be below the UL subband. In this case, the UE provides the gNB with two measurement reports corresponding to the two subbands, namely, the one below and the other one above the UL subband. In this case, the size of the CSI-wideband-subband may differ from the predefined sizes of a regular CSI subband. The aforementioned solutions for subband reporting may be extended to CSI-wideband-subband, for example, for the determination of the frequency location of CSI-wideband-subband relative to the CRB and for the determination of which CSI-wideband-subband is to be reported based on UE capability. The UE may expect that for each indicated CSI subband to be reported, the CSI-RS or CSI-IM linked to this report should at least be mapped to the RBs spanned by this CSI subband. Time domain enhancements may include the following. In legacy NR, for different reporting quantities, if RRC parameter timeRestrictionForChannelMeasurements or timeRestrictionForInterferenceMeasurements is set configured, the UE shall derive the indicated channel or interference measurements using only the most recent, no later than the CSI reference resource, occasion of synchronization signal block (SSB) or CSI-RS. On the other hand, when it is set to notconfigured, it is up to UE implementation to choose which SSB(s) or CSI-RS(s) (and whether to average them or not) no later than the CSI reference resource to derive the indicated channel or interference measurements. In full-duplex operation, with the presence of UL subband, which CSI-RSs or SSBs may be averaged together may be clarified to avoid providing corrupted reports to the gNB. The reason is that the interference situation may vary between the instances of CSI-RS and SSB transmitted when a UL subband is present and the instances transmitted when a UL subband is not present. Another reason that averaging may be corrupted is that the gNB may change the used antennas/panels between the symbols containing a UL subband and the symbols that do not contain a UL subband. Similarly, in NES, the gNB performs spatial domain adaptation or power domain adaptation. If the UE averages the RS instances transmitted using different spatial/power modes, the reported quantity may be corrupted. Therefore, the solutions described herein may be applicable to both full-duplex and NES operations as the root cause of the problem is similar.

As one possibility, based on the received configurations of the UL subband, the UE may determine which CSI-RS/SSB collides with the UL subband. In this case, it may be beneficial that the UE provides two reports to the gNB. For example, the first report may correspond to the reference signals that collide with UL subband (this first report may be referred to herein as a “dirty report”) and the second report may correspond to the reference signals that do not collide with UL subband (this second report may be referred to herein as a “clean report”). The UE may provide the gNB with a clean report, dirty reports, or both either in the same or different reporting instances; the determination may be based on the provided configurations from gNB by higher layer signaling such as RRC or MAC-CE or even dynamic indication in DCI. Also, the UE may indicate to the gNB, through UE capability signaling for example, whether it handles clean reports and dirty reports. For instance, the UE may indicate that it supports providing clean reports only, dirty reports only, or both. Compared with full-duplex operation in which the UE may indicate its capability relative to two report types, in NES operation, the UE may report its capability relevant to the reports associated with different spatial or power domain patterns. For example, the UE may indicate to the gNB as part of its capability signaling the maximum number of reports associated with a maximum number of spatial domain patterns, power domain patterns, or both spatial and power domain patterns. Also, in some embodiments, the gNB does not request a UE to report CSI involving CSI-RS occasion (orthogonal frequency domain multiplexing (OFDM) symbol or slot) including CSI-RS that is punctured frequency domain portion which is not informed to a UE. Though two reports may be used in full-duplex operation depending on the presence or absence of a UL subband, it should be understood that more than two reports may be needed in NES operation. Specifically, there may be multiple reports corresponding to different spatial or power patterns. Therefore, the solutions described herein may be extended in case of using more than two reports in case of NES.

Distinguishing between clean reports and dirty reports may be beneficial on many occasions, such as, for example, when a gNB (A) operates in legacy TDD operation mode and the neighboring gNB (B) operates in full-duplex mode. In this case, the interference levels experienced by a UE served by gNB (A) varies depending on whether or not the measured RS collides with UL existing subband from gNB (B). Even for a single gNB operation wherein the existence of UL subband varies with the time, the interference level varies depending on the surrounding UEs and whether or not they are scheduled to transmit UL. Moreover, the nature of the measured RS or report may vary depending on how the collision between the RS or reporting band and UL subband is handled, as described in this disclosure. Moreover, when the gNB operates in full-duplex, it may need to adapt its antennas, panels, ports, RF chains, or transmission power in SBFD symbols to use settings or configurations differing from those employed for regular DL symbols. In this case, having multiple reports may be beneficial as such that the gNB may apply the proper configurations depending on the used antennas, panels, RF chains, or transmission power. Similarly, when the gNB operates in NES mode, two or more reports may be needed such that the gNB can apply the proper configurations depending on the used adaptation patterns in spatial domain or power domain.

This approach is beneficial for NZP-CSI-RS used for channel measurements or interference measurements and for CSI-IM as well. For example, if no enhancement is developed to support non-contiguous allocation for NZP-CSI-RS or CSI-IM resource around the UL subband, the UE assumes the CSI-RS or CSI-IM resource occupies contiguous RBs which cannot be realized when the UL subband is present. Also, the serving gNB may not use full-duplex operation, but the neighbor cell may operate in full-duplex mode based on UL subband in particular time occasions. In this case, the experienced inter-cell interference level varies depending on whether the measurements are conducted when the UL subband of the neighbor cell is present or not.

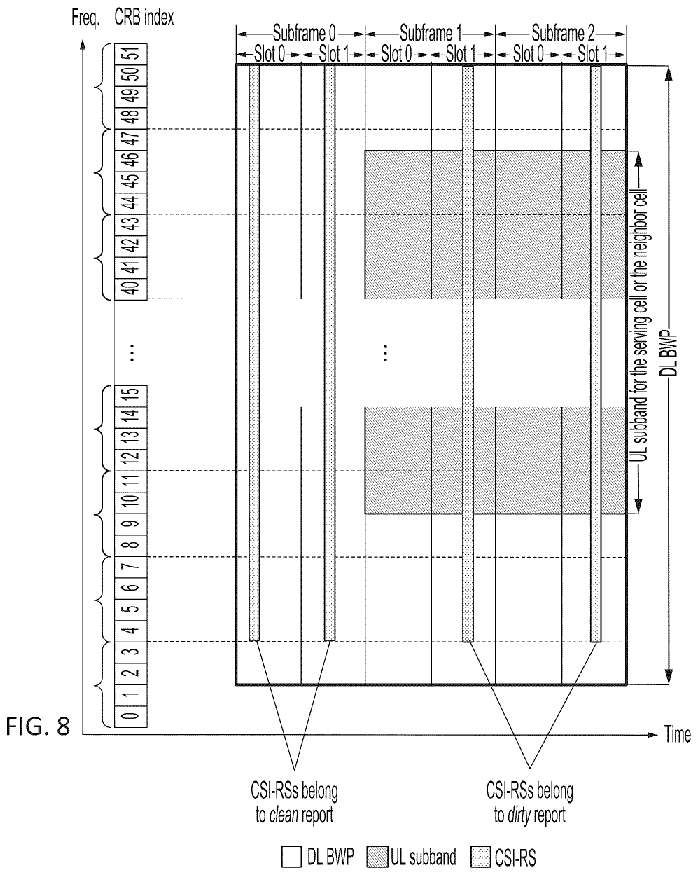

FIG. 8 shows an example of 4 CSI-RS wherein the first and second CSI-RS do not collide with the UL subband while the third and fourth CSI-RS collide with the UL subband for either the serving gNB or the neighbor cell. In this case, the UE may assume the first two CSI-RSs belong to the clean report while the last two CSI-RSs belong to the dirty report. To derive the required measurement quantities, the UE may only average CSI-RSs belonging to the same reporting type.

The UE may determine which NZP-CSI-RS or CSI-IM resource belongs to the clean report or dirty report by checking the overlap between the RSs and UL subband, if its configurations are provided to the UE. The NZP-CSI-RSs or CSI-IM resources that do, or do not, overlap with the UL subband belong to the dirty report, or to the clean report, respectively. However, the configurations of UL subband may not be provided to the UEs, e.g., the UL subband may be transparent to the UE. In this case, a more explicit indication may be provided to help the UE to determine which NZP-CSI-RSs or CSI-IM resources belong to the clean report or dirty report. Moreover, explicit indication may also be needed when there are more than two reports corresponding to multiple spatial or power domain patterns in case of network energy saving operation.

As one possibility, the gNB may indicate to the UE which NZP-CSI-RS(s) or CSI-IM resources are to be used for the clean report or the dirty report through higher layer signaling, e.g., RRC parameter reportCat that may be set to clean or dirty. This may be equivalent to a bitmap consisting of one bit indicating whether NZP-CSI-RS(s) or CSI-IM resources belong to a clean report or a dirty report. In full-duplex operation, the gNB may switch between two antenna configurations. In this case the RRC parameter may be a two-bit field indicating whether the whether NZP-CSI-RS(s) or CSI-IM resources are transmitted using the first or second antenna configuration. In case of multiple reports for NES operation, the gNB may switch between more than two antenna configurations corresponding to multiple spatial or power domain patterns. In this case, the RRC parameter may have N bits corresponding to N spatial or power domain patterns where each bit maps to one pattern. In the legacy CSI framework CSI-ResourceConfig may include the resource set, i.e., NZP-CSI-RS-ResourceSet, CSI-SSB-ResourceSet, or CSI-IM-ResourceSet, and indicate whether it is aperiodic, semi-persistent or periodic. Therefore, reportCat may be a part of the configurations of the resource set. In this case, all the resources belonging to a particular resource set may be used for generating the clean report or the dirty report.

To have finer granularity indication, reportCat may be part of configurations of the resources themselves, i.e., NZP-CSI-RS-Resource, SSB-Index or CSI-IM-Resource. Therefore, within a particular resource set, different resources may either belong to the clean report or to the dirty report or to a spatial or power domain pattern in case of NES operation. Whether reportCat is included in the resource set configurations or in the resources themselves, the gNB has control to configure the periodicity and offset, when applicable, such that the resources do not collide with the UL subband for a clean report or are overlapped with the UL subband in case of a dirty report.

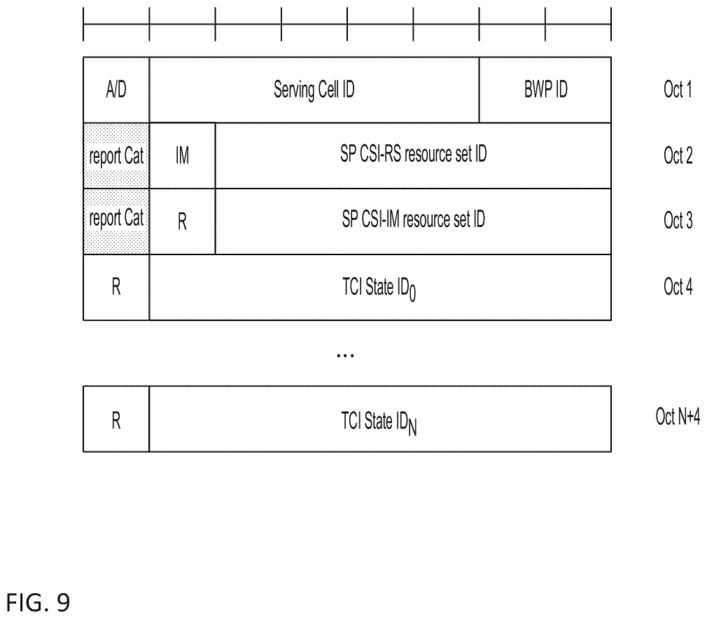

To further provide the gNB with more flexibility to indicate whether NZP-CSI-RS(s) or CSI-IM resources belong to a clean report, a dirty report, or a spatial or power domain pattern in case of NES operation, dynamic indication may be used, in addition to the aforementioned semi-static indication by RRC. For example, the activation MAC-CE command of the semi-persistent CSI-RS or semi-persistent CSI-IM may carry an indication for each activated NZP-CSI-RS set or CSI-IM resource set specifying whether the set belongs to the clean or dirty report. For example, the reserved bits in each octet indicating the set ID may be used to carry 1-bit indicating whether the activated set is considered for a clean report or a dirty report as shown FIG. 9. Moreover, multiple bits may be used to indicate which antenna or power configurations the UE should assume. In full-duplex operation, two bits may be used, one for full-duplex operation and another for non-full-duplex operation. In case of NES, N bits may be used for N spatial or power domain patterns, i.e., one bit for each pattern. For aperiodic reporting or SP CSI on PUSCH, either the RRC parameter reportCat consisting of a single bit or multiple bits is included in CSI-AssociatedReportConfigInfo as part of CSI-AperiodicTriggerState or CSI-SemiPersistentOnPUSCH-TriggerState, or one bit or multiple bits field in the activation DCI itself.

As yet another possibility to enable the UE to determine the resources to be used to derive the clean report and dirty report is that the gNB may provide the UE with periodicity and offset for the occasions in which the UL subband occurs. When the measured resource overlaps with the UL subband, the UE assumes that this resource is used to derive the dirty report. Similarly, in NES operation, the gNB may provide the UE with multiple periodicities and offsets for the occasions in which different spatial or power domain patterns occur. In this case, the UE determines the applicable spatial or power domain pattern based on the time domain overlapping between the resource and indicated spatial or power domain pattern.

Alternatively, the gNB may provide the UE a single bitmap or multiple bitmaps to indicate which NZP-CSI-RS-Resource, SSB-Index or CSI-IM-Resource belong to the clean or dirty reports or a spatial or power domain pattern in case of NES operation. For example, if the time domain location of the measured resources overlap with the time domain resources, e.g., OFDM symbols, slots, subframes, etc., indicated by the clean/dirty bitmap, the UE may assume these measured resources correspond to the clean or dirty report, respectively. Each bit may correspond to a single time domain resource, or to multiple time domain resources. For example, each bit may correspond to two consecutive slots. The mapping granularity between each bit in the bitmap and the time domain resources may be configured by higher layer signaling or predefined in the specs.

There may be a single bitmap indicating the time domain resources of the clean report and the time domain resources not indicated by this bitmap are assumed to be associated with the dirty report, or vice versa, or two bitmaps may be used, one for the clean report and another for the dirty report or more than two bitmaps in case of multiple spatial or power domain patterns in case of NES operation. The same resource may not be indicated by both bitmaps simultaneously in case of full-duplex operation or the same resource may not be indicated by multiple bitmaps simultaneously in case of NES operation.

Rather than associating the bitmap(s) with the time domain location of the measured resources themselves, the same procedures may be extended such that the bitmap(s) may be associated with the time domain location in which the report is to be transmitted. All the measurement resources that are linked with that report are assumed to be clean or dirty based on the bitmap(s) indication in case of full-duplex operation. Similarly, all the measurement resources that are linked with that report are assumed to follow the same spatial or power domain pattern based on the bitmap(s) indication. The UE may not expect for the same RS to be associated with multiple reports some of which are indicated as clean and others of which are indicated as dirty or multiple reports indicated to have different spatial or power domain patterns.

In such a setup, the UE may report the clean report and the dirty report in the same reporting occasion or report multiple reports for different power or spatial domain patterns. To reduce the reporting payload size, when applicable, differential reporting may be used. Taking L1-RSRP/SINR as an example and assuming nrofReportedRS is set to “n2”, the UE may be report two L1-RSRP/SINR based on the on the RS associated with the clean report and another two L1-RSRP/SINR based on the RS associated with the dirty report.

To enhance the reporting resolution, two absolute RSRPs of the best CRI/SSBRI among RSs associated with the clean report and dirty report may be reported using 7 bits, as shown in Table 3. While differential reporting using 4-bits is used among the RSs that are associated with the same report type. The reports of RS associated with clean report may be reported first followed by the reports of RS associated with dirty report. The same concept may be extended to the case in which there are multiple reports associated with different spatial or power domain patterns. For example, 7 bits may be used for a report with the most (least) antennas/ports or with the highest (lowest) transmit power and 4 bits for differential reporting for the subsequent reporting with less (more) antennas/ports or with lower (higher) transmit power, respectively.

TABLE 3

| RS type | Reporting format |
|---|---|
| Belong to clean report | CRI or SSBRI #1 |
| Belong to clean report | CRI or SSBRI #2 |
| Belong to dirty report | CRI or SSBRI #1 |
| Belong to dirty report | CRI or SSBRI #2 |

7 bits RSRP for clean CRI/SSBRI #1
4 bits differential L1-RSRP/SINR for clean CRI/SSBRI #2
relative to the best beam among the clean RSs
7 bits L1-RSRP/SINR for dirty CRI/SSBRI #1
4 bits differential L1-RSRP/SINR for dirty CRI/SSBRI #2
relative to the best beam among the dirty RSs

Table 3 shows reporting of two absolute L1-RSRP/SINR for the best RS associated with each reporting type. In this embodiment, differential L1-RSRP/SINR is relative to the best RS in the same reporting type.

As another possibility to reduce the reporting payload size, only a single absolute L1-RSRP/SINR of the best RS among all the RSs associated with clean report or dirty report is reported. All other reported L1-RSRP/SINR, regardless whether the RS is associated with a clean report or a dirty report, is reported using differential reporting relative to the best L1-RSRP/SINR. This is similar to legacy reporting of L1-RSRP/SINR, but a difference is that the UE needs to report two measurements of RSs, associated with a clean report or a dirty report, respectively, when nrofReportedRS is set to “n2”, for example. The same concept may be extended to case in which there are multiple reports associated with different spatial or power domain patterns where the UE may report two measurements of RSs, associated with each report for a particular spatial or power domain pattern, when nrofReportedRS is set to “n2”, for example.

Table 4 shows reporting of one absolute L1-RSRP/SINR for the best RS among all RSs associated with both reporting types. In the embodiment of Table 4, differential L1-RSRP/SINR is relative to the best RS.

TABLE 4

| | Reporting format |
|---|---|
| UE reports the best two RSs | CRI or SSBRI #1 |
| from the RSs associated | CRI or SSBRI #2 |
| with the clean report and | CRI or SSBRI #3 |
| the best two RSs from the | CRI or SSBRI #4 |
| RSs associated with the | 7-bits RSRP for CRI/SSBRI #1 |
| dirty report | 4-bits differential L1-RSRP/SINR for |
| | CRI/SSBRI #2 relative to CRI/SSBRI #1 |
| | 4-bits differential L1-RSRP/SINR for |
| | CRI/SSBRI #3 relative to CRI/SSBRI #1 |
| | 4-bits differential L1-RSRP/SINR for |
| | CRI/SSBRI #4 relative to CRI/SSBRI #1 |

Although the aforementioned example is for L1-RSRP/SINR, the same concept may be extended for other reporting quantities as well. For example, differential CQI across different reports may be provided to reduce the report payload size.

Alternatively, the gNB may indicate to the UE whether to report the required quantities for RS associated with a clean report or a dirty report or both. For example, as part of the report configurations, CSI-ReportConfig, a new RRC parameter may be introduced to indicate what the UE should report and it may be set to clean, dirty or both. In case of full-duplex operation, the gNB may switch between two antenna configurations. In this case the RRC parameter may be a two-bit field indicating whether the whether NZP-CSI-RS(s) or CSI-IM resources linked to this report are transmitted using the first or second antenna configuration. In case of NES, the gNB may switch between more than two antenna configurations corresponding to multiple spatial or power domain patterns. In this case, the RRC parameter may have N bits corresponding to N spatial or power domain patterns where each bit may map to one pattern. Moreover, for aperiodic reporting, the indication of which reporting type (clean, dirty or both) to include may be carried in the triggering DCI as well. Similarly, for SP reporting, the triggering MAC-CE may indicate which report type (clean, dirty or both) is to be included. Similar to FIG. 9, some reserved bits in SP CSI reporting on PUCCH activation/deactivation MAC CE may be used to indicate the used spatial or power domain pattern or indicate whether SBFD or non-SBFD should be assumed or a new MAC-CE may used to carry this field in addition to legacy fields indicating the activated SP CSI report. For example, a single bitmap may indicate the applicable pattern for all activated SP CSI reports. This bitmap may be similar to the aforementioned RRC parameter. To reduce the field size, the field in MAC-CE may indicate the index of a particular spatial or power domain pattern among a list configured by RRC or a sub list constructed by another MAC-CE activating a set of spatial or power domain patterns from those configured by RRC. To provide the gNB with more flexibility, separate fields may be included in the MAC-CE for each activated SP CSI report.

If such a parameter is not configured, a default behavior may be predefined, i.e., provided in the specs, and it may be only a report of the measurement derived from a RS associated with a clean report.

The UE may indicate to the gNB whether it supports performing measurements or reporting for RS associated with clean report and dirty report. Such an indication may be carried as part of UE capability signaling.

To avoid explicitly providing the UE with the configurations of the UL subband, the gNB may indicate to the UE which set(s) of RBs does not carry CSI-RS. In this case, the UE may not use those set(s) of RBs to derive the channel estimation and subsequent reporting quantities. Similar to timeRestrictionForChannelMeasurements or timeRestrictionForInterferenceMeasurements, higher layer signaling may provide the UE with a frequency domain restriction indicating which set of RBs may be used or not used to derive the channel estimation. For example, RRC parameters such as freqRestrictionForChannelMeasurements and freqRestrictionForInterferenceMeasurements may be introduced to indicate the set(s) of RBs that should be excluded when the UE conducts channel estimation. A bitmap may be used to indicate the excluded set of RBs, or indicating the start and length of the set of RBs based on a Resource Indication Value (RIV) approach may be used as well. For a bitmap-based solution, each bit may correspond to a singleRB or a group of RBs. The gNB may indicate to the UE the granularity/resolution of each bit in the bitmap.

The UE may determine which portions of NZP-CSI-RS, CSI-IM resource or SSB may be averaged together or not based on the intersection between {timeRestrictionForChannelMeasurements and freqRestrictionForChannelMeasurements} for channel measurements and between {timeRestrictionForInterferenceMeasurements, freqRestrictionForInterferenceMeasurements} for interference measurements.

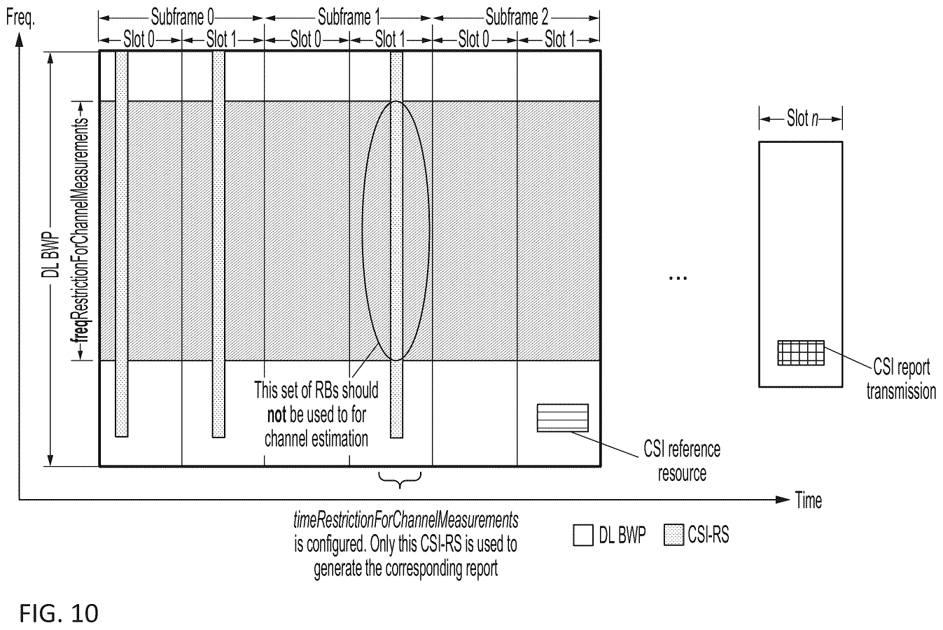

FIG. 10 shows an example in which both timeRestrictionForChannelMeasurements and freqRestrictionForChannelMeasurements are configured. In this case, the UE uses the most recent CSI-RS and excludes the set of RBs indicated byfreqRestrictionForChannelMeasurements while estimating the channel.

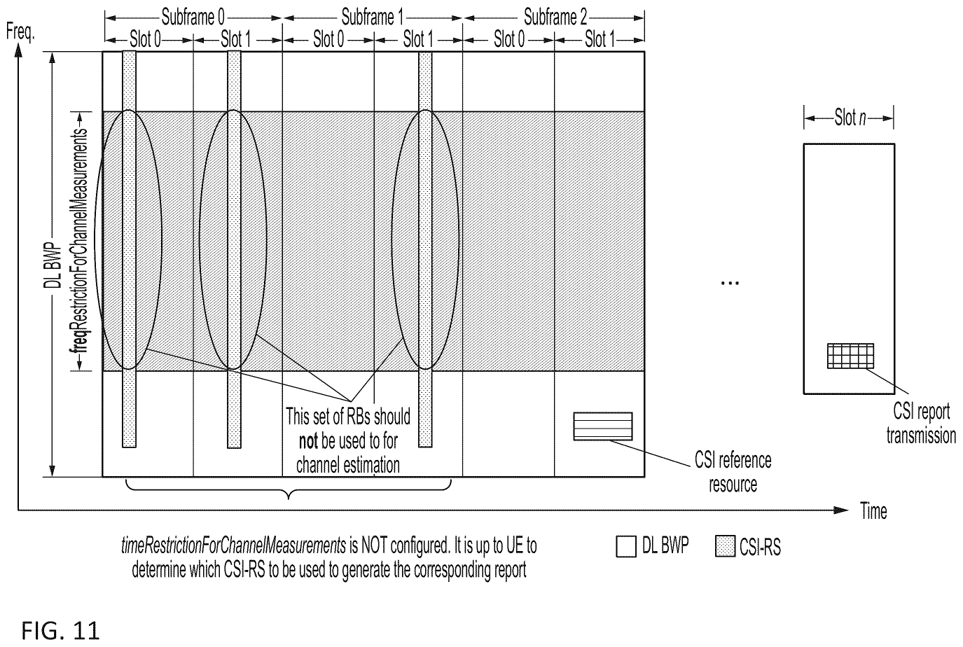

On the other hand, when timeRestrictionForChannelMeasurements is not configured, but andfreqRestrictionForChannelMeasurements is configured, the UE may use multiple RSs preceding the CSI reference resource to generate the required report. At the same time, the UE may not use the set of RBs indicated byfreqRestrictionForChannelMeasurements for estimating the channel, as exemplified in FIG. 11.

When time domain restriction is not configured, the UE may expect CSI-RSs to either occupy either contiguous or non-contiguous RBs, but the UE may not expect a mixture of both types of CSI-RSs. Also, this rule (different types of CSI-RSs punctured or non-punctured do not coexist) may be applied for a particular time window. The duration of the time window (“L”) may be unit of OFDM symbols, slots, etc. It may start with “L” symbols, slots, etc., before the first symbol, slot, etc., of the CSI reference resource or CSI transmission occasion.

Even if the UE is provided with UL subband configurations, frequency domain restrictions on the RBs that may be used for estimating the channel or interference, indication of RS associated with clean or dirty report, etc., the UE may not be able to perform such advanced channel estimation. In this case, it may be beneficial that the UE indicates its own capability as part of capability signaling, for example. The UE may indicate that even if the configurations are provided to the UE, the UE is not required to provide a valid CSI report when the RS used to derive the measurement report becomes non-contiguous.

The solutions herein may be applied for SSB resources used for CSI measurement in a manner similar to that for NZP-CSI-RS and CSI-IM resources. Any solutions that may be used for NZP-CSI-RS or CSI-RS may be easily extended to CSI-IM resources.

Depending on the gNB implementation, the gNB may be able to use all its RF chains for regular DL symbols or slots, but it may not be able to use all its RF chains in subband full-duplex (SBFD) symbols or slots. In other words, the gNB may need to disable some of its RF chains, antennas, ports in SBFD symbols or slots compared with regular DL symbols. For example, the gNB may need to reduce its transmit power in SBFD symbols or slots to reduce the impact of self-interference so that it is within acceptable limits. In other words, the gNB may need to reduce its transmit power in SBFD symbols or slots compared with regular DL symbols. Similarly, in NES operation, the same gNB may perform similar procedures for energy saving. Specifically, the gNB may need to adapt its antennas or transmit power to be aligned with the applicable spatial or power domain pattern for energy saving. Therefore, the solutions herein may be easily extended for NES with more than two reports associated with multiple spatial or power domain patterns.

Such operation may be problematic for P/SP CSI-RS when the power of P/SP CSI-RS may vary from one occasion to another depending on whether such occasion falls on SBFD symbols or slots or non-SBFD symbols or slots or falls on durations in which a different power domain pattern is applied in case of NES operation. For example, if the UE reports CSI quantities such as CQI, the reported value depends on the power offset between CSI-RS and PDSCH that is provided by powerControlOffset in legacy NR. The implicit restriction is that P/SP CSI-RS is transmitted with a fixed power in each occasion which may not be feasible in SBFD or NES operation as described above.

In this case, it may be beneficial if the gNB provides the UE with information about the power offset between the CSI-RS occasions falling in SBFD symbols or slots and non-SBFD symbols and between the CSI-RS occasions falling in the durations in which different power domain patterns are applied in case of NES operation. Based on this information, the UE may report the corresponding metric using the valid assumption regarding the transmit power of CSI-RS. This is similar to clean and dirty report where the clean report is determined based on CSI-RS in non-SBFD symbols or slots and dirty report is in SBFD symbols or slots, respectively. This may also be equivalent to two power domain patterns in case of NES operation. However, more than two reports may be used in case of multiple power domain patterns.

One possibility is that the gNB provides the UE with an additional powerControlOffset via RRC signaling such as powerControlOffset2. In this case, if the UE derives the CSI report, e.g., CQI, the UE applies powerControlOffset or powerControlOffset2 based on whether CSI-RS used for calculating the CSI report is in SBFD symbols or slots or non-SBFD symbols or slots. Similarly, in NES operation, an additional power control offset may needed when there are two power domain patterns. It should be understood that in general, when there are more than two power domain patterns more than two power control offset parameters are needed for each report associated with particular power domain pattern. If the CSI-RS is in non-SBFD symbols or slots, the legacy powerControlOffset may be used. If the CSI-RS is in SBFD symbols or slots, the powerControlOffset2 may be used. This may be equivalent topowerControlOffset2 overriding powerControlOffset. The additional power offset to be used when CSI-RS collides with SBFD may be provided as an offset relative to legacy powerControlOffset via RRC signaling rather than configuring powerControlOffset2. This may be equivalent to providing a delta value to legacy powerControlOffset. A similar concept can be extended to NES with two power domain patterns and the concept can be easily extended for more than two reports when there are more than two power domain patterns. For either full-duplex or NES operation, the applied power offset of particular CSI-RS may depend on the report linked with the CSI-RS which may clean or dirty in full-duplex operation or particular report corresponding to specific spatial or power domain pattern.

Alternatively, the offset value may be predefined, e.g., provided in the specifications. In this case, the predefined offset is applied on the top of the signaled powerControlOffset when the CSI-RS is transmitted in SBFD symbols or slots or the CSI-RS is linked to a particular report corresponding to a specific spatial or power domain pattern.

This approach may be applied for SP/P CSI-RS regardless of whether the CSI reporting type is aperiodic, periodic or semi-persistent. For example, if P-CSI-RS is linked with AP-CSI reporting, the UE may apply the proper power offset between P-CSI-RS and PDSCH when deriving the CSI report depending on whether the P-CSI-RS used for deriving the report is transmitted in SBFD symbols or slots or non-SBFD symbols or slots or is transmitted according a particular power or spatial domain pattern in case of NES operation.

Similarly, when AP-CSI-RS is linked with an AP-CSI report, two power offset values may be applied depending on whether the AP-CSI-RS is in a SBFD symbol or a non-SBFD symbol or is transmitted according to a particular power or spatial domain pattern in case of NES operation. In addition of the aforementioned for providing the additional offset to the UE, the DCI triggering the AP-CSI RS may indicate the offset value to powerControlOffset or directly indicate powerControlOffset2 to be applied. For example, RRC may configure multiple offset values and the DCI may indicate which one is to be applied. For example, a new field may be used. This is beneficial if the reflectors around gNBs vary with the time causing the self-interference intensity to vary. Specifically, in some occasions, CSI-RS in SBFD symbols or slots is transmitted with the same power as in CSI-RS in non-SBFD symbols or slots. In this case, the DCI triggering AP-CSI-RS and AP CSI report may indicate no additional power offset is needed.

Even if the CSI-RS(s) used for deriving a CSI report are clean (and do not collide with UL subband) or dirty (and collide with the UL subband) or associated with a particular spatial or power domain pattern, it may be beneficial if the UE is provided with two or more power control offsets between the measured CSI-RS(s) and the potential PDSCH to be transmitted. For example, even if clean CSI-RS(s) are used for CSI measurement, the gNB may be interested in scheduling PDSCH in a SBFD symbol, referred to as a dirty PDSCH, with less power compared with scheduling PDSCH in a non-SBFD symbol, referred to as clean PDSCH. In this case, the gNB may need separate CSI reports to determine the proper parameters of PDSCH based on whether it will be a clean PDSCH or dirty PDSCH. The same example may be easily extended to NES with multiple spatial or power domain patterns.

The aforementioned techniques to provide the UE with two powerControlOffset(s), e.g., in the configurations of CSI-RS, may be applied here as well even if all CSI-RS(s) used for deriving CSI report are clean, dirty, or correspond to particular spatial or time domain patterns. For example, the gNB may provide the UE with powerControlOffset2 via RRC signaling as described earlier. In this case, even if all CSI-RSs used for deriving a CSI report are clean, the UE may provide clean or dirty CSI reports based on both configured power offsets. The same example may be easily extended to NES with multiple spatial or power domain patterns.

As described earlier, the gNB may configure or indicate to the UE which report (clean, dirty, or both) is to be provided, for example, as part of CSI report configuration a new parameter may be introduced to indicate whether the report is clean or dirty and which power offset should be used among those provided as part of CSI-RS configurations. Similarly, for NES, as part of the CSI report configurations, the gNB may indicate that the report is associated with a particular spatial or power domain pattern and indicate which power offset should be used as described herein. For example, if the UE is provided with two power control offsets, the UE may assume that two reports will be provided. Alternatively, the gNB may explicitly indicate the report nature (clean or dirty) by MAC-CE or DCI triggering the CSI report.

As another possibility, the report nature (clean or dirty) may be determined based on whether PUCCH or PUSCH carrying the report falls in an UL subband or regular UL BWP. For example, if PUXCH carrying the CSI report falls in the UL subband, then the UE may use the parameters related to the dirty CSI report, otherwise the parameters associated with the clean report may be used.

The gNB may provide the powerControlOffset(s) in the report configurations, e.g., CSI-ReportConfig, instead of or in addition to providing it in NZP-CSI-RS-Resource. This is beneficial when a particular CSI-RS is linked to two reports. In this case, providing powerControlOffset(s) in report configurations informs the UE which power offset should be assumed when the UE derives the indicated report quantities using the linked CSI-RS(s). This enables the gNB to link the same CSI-RS with two or more reports where a different power offset between CSI-RS and PDSCH is assumed for each CSI report separately. This may be equivalent to powerControlOffset in the report configurations, e.g., CSI-ReportConfig, overriding powerControlOffset in the CSI-RS configurations, or it may a delta value to powerControlOffset in the CSI-RS configurations.

One possibility is to assume that powerControlOffset(s) is provided either in the configurations of CSI-RS or CSI report, but not in both of them. In other words, the UE does not expect the power offset parameters to be provided in both linked CSI-RS and CSI report. Alternatively, the power offset may be provided in both of them. The UE may interpret them as shown in Table 5, which shows power offset information. Though Table 5 is applicable for full-duplex operation or NES with two spatial or power domain patterns, it should be understood that it can be easily extended to the case of more than two spatial or power domain patterns in NES operations.

TABLE 5

| Power offset | Power offset | |
|---|---|---|
| information is | information is | |
| provided as part of | provided as part of | |
| CSI-RS | CSI report | |
| configurations | configurations | UE behavior |
| Yes | No | The UE applies power offset based on the CSI- |
| | | RS(s) used for deriving the measurement report. |
| | | For example, if the UE uses the clean (dirty) |
| | | occasion of CSI-RS, then the power offset |
| | | associated clean (dirty) CSI-RS is applied, |
| | | respectively. If the UE is configured to use both |
| | | clean and dirty occasions of CSI-RS and report |
| | | two reports, then the corresponding power |
| | | offset of each CSI-RS based on its type being |
| | | either clean or dirty will be used. |
| | | Applying which power offset may depend on the |
| | | nature of CSI-RS being clean or dirty or the |
| | | nature of the required CSI report as described |
| | | earlier. |
| No | Yes | The UE applies the power offset in the CSI report |
| | | configuration when deriving the CSI report. |
| Yes | Yes | If only one type (clean or dirty) of CSI-RS |
| | | is used for deriving the CSI report, e.g., |
| | | time restriction is configured and only |
| | | one CSI-RS is used and it can be either |
| | | clean or dirty, the power offset in the |
| | | CSI report is to be applied and the UE |
| | | may ignore the power offset in the CSI- |
| | | RS configurations. |
| | | If more than one type (clean or dirty) of |
| | | CSI-RS can be used for deriving the CSI |
| | | report, e.g., time restriction is not |
| | | configured and some CSI-RS are either |
| | | clean or dirty and the UE is supposed to |
| | | report both clean and dirty CSI report, |
| | | the power offset in the CSI-RS is to be |
| | | applied and the UE may ignore the |
| | | power offset in the CSI report |
| | | configurations. |
| | | If more than one type (clean or dirty) of |
| | | CSI-RS can be used for deriving the CSI |
| | | report, e.g., time restriction is not |
| | | configured and some CSI-RS are either |
| | | clean or dirty the UE is not supposed to |
| | | report both clean and dirty CSI report, |
| | | the power offset in the CSI report is to |
| | | be applied and the UE may ignore the |
| | | power offset in the CSI-RS |
| | | configurations. |

Though in some embodiments the UE applies the power offset provided in the configurations of either CSI-RS or CSI report, other rules may be applied as well. For example, the power offset for a clean report is the sum of the power offsets provided in the configurations of the CSI-RS and CSI report. The configurations of the CSI report may provide the UE with information about two power offsets associated with clean and dirty reports such that the power offsets for a clean report may be added together and the power offsets for a dirty report may be added together.

CORESET handling may be performed as follows. The CORESET(s) associated with a search space may collide with the UL subband in some PDCCH monitoring occasions. Therefore, it is important to determine the UE behavior regarding this monitoring occasion, when the CORESET collides with the UL subband.

One possibility is that when at least one RE for a PDCCH candidate within the CORESET overlaps with at least one RE configured or indicated for the UL subband, the UE is not required to monitor the PDCCH candidate. This may be beneficial when downlink is not allowed in the UL subband.

On the other hand, if downlink is allowed in the UL subband, then the UE may be required to monitor the PDCCH candidate even if it partially or fully overlaps with the REs configured or indicated for the UL subband. This may be beneficial to provide the gNB with more flexibility when transmitting PDCCH.

Whether or not to monitor the PDCCH candidate when the PDCCH candidate overlaps with the UL subband may depend on the search space. Specifically, the UE is not required to monitor the PDCCH candidate overlapping with the UL subband if the PDCCH candidate is not a Type0-PDCCH CSS set. For Type0-PDCCH CSS, the UE may assume no UL subband overlap with the CORESET associated with that search space.

Moreover, if the UL subband is indicated to be canceled or deactivated, the UE may monitor PDCCH in a manner similar to that of legacy procedures as the UL subband is not present any more.

As another alternative to handle this case is that RBs of the CORESET that collides with the UL subband are excluded from the CORESET (and, e.g., the UE does not monitor these RBs). Also, since the CORESET is configured in a group of 6 RBs, the whole group of RBs may be excluded from the CORESET if any RB in the group collides with the UL subband. In this case, it may be beneficial that the set of RBs belonging to the CORESET does not change for a particular duration to simplify the UE implementation.

For example, in at least the duration of x slots, all the PDCCH monitoring occasions are associated with the CORESET that has the same RBs. In slot x+1, the RBs belong to the CORESET may change due to colliding with the UL subband and it remains the same for at least another x slots. This duration may be equal to one period of SS. In this case, the CORESET associated with all the monitoring occasions in one period should have the same RBs as a result of colliding or not colliding with the UL subband. The UE may indicate to the gNB the duration for which the RBs belonging to the CORESET do not change via capability signaling for example. Moreover, the duration for which the RBs belonging to the CORESET do not change may be predefined, i.e., provided in the specs. Duration in this context may also refer to the minimum duration for which the RBs belonging to the CORESET do not change.

The UE may indicate to the gNB whether it supports handling the case in which the RBs belonging to a CORESET associated with a search space change due to collision with the UL subband. This indication may be via capability signaling.

Enhancements to mitigate gNB-to-gNB cross link interference (CLI) may include the following. When neighboring gNBs use different UL subband configurations or even some of them operate according to legacy TDD operation and others operate in full-duplex mode, this may create interference among them. This applies for gNBs belonging to the same operator or to different operators. The gNB is considered as an “aggressor” gNB when it transmits DL that fully or partially overlap in time domain or frequency domain with UL reception of another gNB that may be denoted as a “victim” gNB.

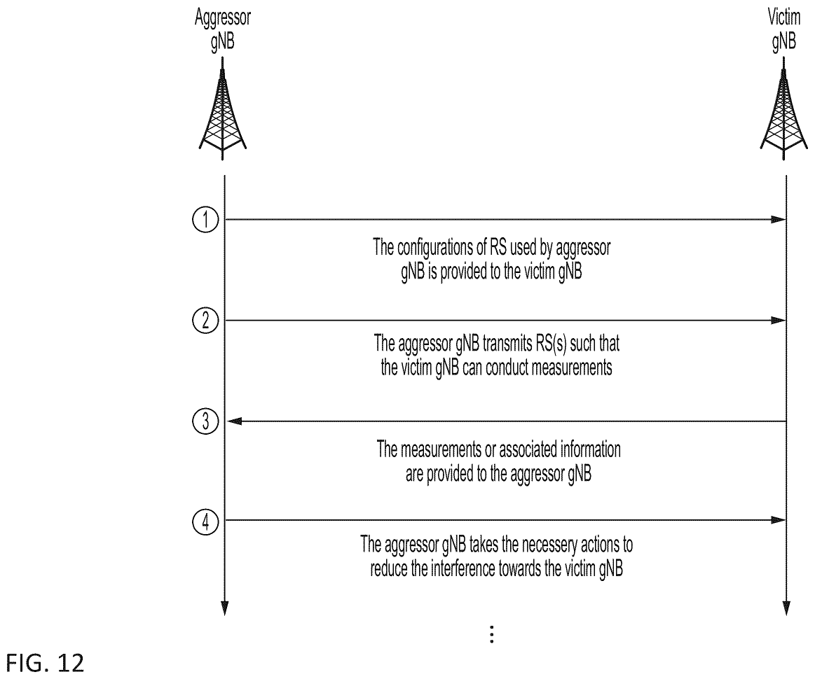

Measurements and coordination among gNBs may be performed as follows. It may be beneficial to enable the victim gNB to measure the strength of different beams transmitted by the aggressor gNB. Based on such measurements, the aggressor gNB may use such information when operating in full-duplex mode to minimize the interference caused to the victim gNB. FIG. 12 shows a high-level description of the procedure to enable gNB-to-gNB CLI measurements.

In step 1, the necessary configurations for the RS transmitted by the aggressor gNB are provided to the victim gNB. More details are provided below, regarding what RS may be used for this purpose and how such configurations may be delivered to the victim gNB. In step 2, the aggressor gNB transmits a single RS or multiple RSs that possibly correspond to multiple beams that the aggressor gNB intends to use for DL transmission. Further details are provided below regarding how such information may be provided to the victim gNB. The victim gNB, in step 3, measures the beam strength of different received RSs. Such measurement or associated information may be provided to the aggressor gNB to take the necessary action as shown in step 4.

Steps 1 and 2 relate to the RS and its configurations. The configurations of the RS used for this purpose may be predefined, i.e., provided in the specs, such that both the aggressor gNB and the victim gNB are aware of them. Also, such configurations may be provided by the Operation and Maintenance (OAM) of the network. Such approach is beneficial to reduce the signaling overhead.

To further enhance the flexibility and avoid transmitting RS in a beam direction in which the aggressor gNB has no DL transmission and does not cause any CLI to the victim gNB, it is beneficial enable the aggressor gNB to announce the configurations of the RS used for the purpose of measuring gNB-to-gNB CLI. One possibility is that aggressor gNB may broadcast such configurations as part of RMSI or other system information (OSI) to enable the victim gNB to receive it. Alternatively, the aggressor gNB may provide configurations of such RS to the neighbor gNB using backhaul signaling over an Xn interface, for example.

One candidate for RS for this purpose is CSI-RS/SSB/CSI-IM resource. This is beneficial because the legacy beam management framework may be inherited as much as possible. Only periodic CSI-RS may be used to reduce the signaling overhead.

The aggressor gNB may announce indices of SSB/CSI-RS that correspond to the DL beams that may cause CLI to the neighboring gNBs. It may be unnecessary for such an announcement to have the same signaling hierarchy as the one used for regular UEs. For example, the type is always periodic, and there may be no need to indicate BWP Id as this UE-specific. Also, this CSI-RS is not used for generating CSI for PDSCH reception, hence, powerControlOffset used for defining the power offset between PDSCH and CSI-RS is not needed. Instead, the CSI-RS may be defined relative to the CRB and the victim gNB may be expected to conduct the measurements across all the RBs spanned by the CSI-RS/SSB. Moreover, powerControlOffsetSS may still be used to define the power offset between CSI-RS and SSB that is used as Quasi Co Location (QCL) source reference signal. This may be beneficial for example when the victim gNB applies a single measurement threshold (for SSB beams and CSI-RS beams), e.g., RSRP threshold, to determine whether this beam causes high interference or not. In this case, the victim gNB may need to scale the measured metric, e.g., RSRP, of the CSI-RS beam in order to compare it to the same threshold used for SSB beam.

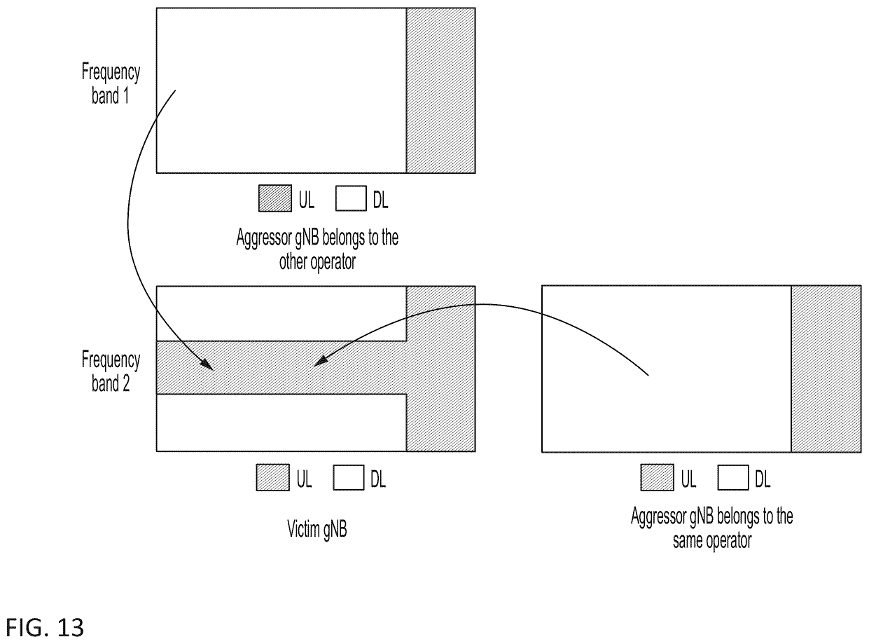

FIG. 13 shows an example in which aggressor gNBs use a legacy TDD system and a victim gNB operates as in full-duplex mode. In this case, legacy CSI-RS may be used. The source QCL RS may be one of the SSBs of the aggressor gNBs. To reduce the signaling overhead, the RRC parameter qcl-InfoPeriodicCSI-RS may directly refer to one of the SSB indices of the aggressor gNB. This is beneficial to reduce the signaling overhead and avoid exchanging the configured transmission configuration indication (TCI) state pool among the aggressor gNB and the victim gNB. This is beneficial as the victim gNB may avoid unnecessary measurements of CSI-RS that are QCLed with SSB from the aggressor gNB in which victim gNB does not intend to receive any UL.

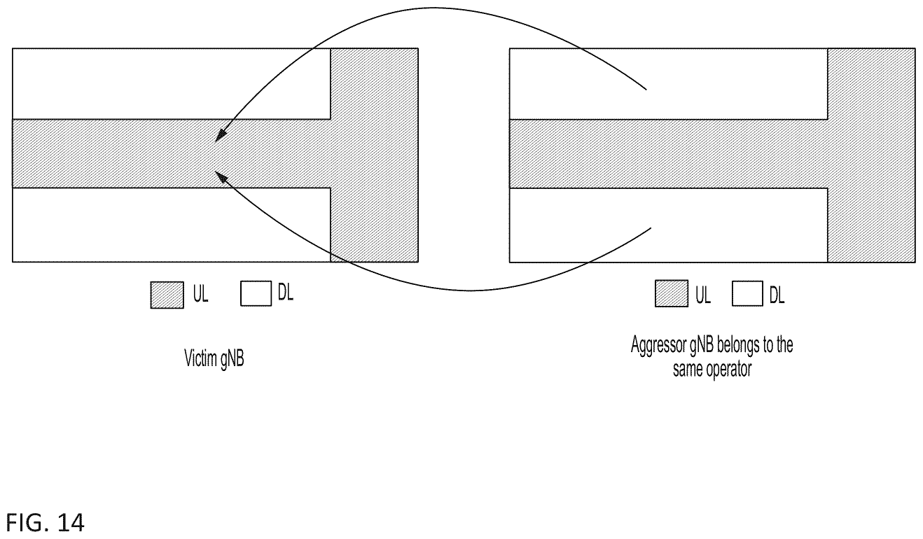

When both the aggressor gNB and the victim gNB operate in full-duplex operation mode, using the legacy CSI-RS may not be efficient because CSI-RS should occupy non-contiguous RBs due to the presence of UL subband as shown in FIG. 14. Though this figure shows the gNB is considered as victim or aggressor, but in this scenario each gNB is victim and aggressor at the same time.

In this case, solutions similar to those presented in this disclosure may be used to enable the CSI-RS to occupy non-contiguous RBs.

The source QCL RS may be one the SSBs of the aggressor gNBs. To reduce the signaling overhead, the RRC parameter qcl-InfoPeriodicCSI-RS may directly refer to one of the SSB indices of the aggressor gNB. This is beneficial to reduce the signaling overhead and avoid exchanging the configured TCI state pool among the aggressor gNB and the victim gNB.

The exemplary IE described in Listing 1 may be transmitted by the aggressor gNB to indicate which CSI-RS/SSB is to be used to assess the gNB-to-gNB CLI.

Listing 1

-- ASN1START
-- TAG-gNB-to-gNB-CLI-RS-START
gNB-to-gNB-CLI-RS ::= SEQUENCE {
nzp-CSI-RS-ResourceList SEQUENCE (SIZE

| | |
|---|---|
| (1..maxNrofNZP-CSI-RS-Resourcesfor-gNBCLI)) OF | NZP-CSI-RS- |
| ResourceIdfor-gNBCLI, | |
| OPTIONAL, -- Need R | |
| SSB-ResourceSetList | SEQUENCE (SIZE(1.. |

maxNrofNZP-SSB-Resourcesfor-gNBCLI)) OF SSB-Index, OPTIONAL -

| | |
|---|---|
| - Need R | |
| }, | |
| } | |
| NZP-CSI-RS-ResourceIdfor-gNBCLI ::= | SEQUENCE { |
| NZP-CSI-RS-ResourceIdfor-gNBCLIId | NZP-CSI-RS- |
| ResourceIdfor-gNBCLIId, | |
| resourceMapping | CSI-RS-ResourceMapping, |
| powerControlOffsetSS | ENUMERATED {db−3, db0, |

db3, db6} OPTIONAL, -- Need R

| | |
|---|---|
| scramblingID | ScramblingId, |
| periodicityAndOffset | CSI- |
| ResourcePeriodicityAndOffset | OPTIONAL, -- Cond |
| PeriodicOrSemiPersistent | |
| qcl-InfoPeriodicCSI-RS | SSB-Index |
| OPTIONAL, -- Cond Periodic | |
| ... | |
| } | |
| CSI-RS-ResourceMapping ::= | SEQUENCE { |
| frequencyDomainAllocation | CHOICE { |
| row1 | BIT STRING (SIZE |
| (4)), | |
| row2 | BIT STRING (SIZE |
| (12)), | |
| row4 | BIT STRING (SIZE |
| (3)), | |
| other | BIT STRING (SIZE |
| (6)) | |
| }, | |
| nrofPorts | ENUMERATED |

{p1,p2,p4,p8,p12,p16,p24,p32},

| | |
|---|---|
| firstOFDMSymbolInTimeDomain | INTEGER (0..13), |
| firstOFDMSymbolInTimeDomain2 | INTEGER (2..12) |
| OPTIONAL, -- Need R | |
| cdm-Type | ENUMERATED {noCDM, fd- |

CDM2, cdm4-FD2-TD2, cdm8-FD2-TD4},

| | |
|---|---|
| density | CHOICE { |
| dot5 | ENUMERATED {evenPRBs, |
| oddPRBs}, | |
| one | NULL, |
| three | NULL, |
| spare | NULL |
| }, | |
| freqBand | CSI-FrequencyOccupation, |
| freqBand_above | CSI-FrequencyOccupation, |

OPTIONAL
...
}
-- TAG-gNB-to-gNB-CLI-RS-STOP
-- ASN1STOP

TABLE 6
gNB-to-gNB-CLI-RS field descriptions

Undefined parameters follow the legacy definitions.
qcl-InfoPeriodicCSI-RS
For a target periodic CSI-RS, directly contains the SSB index a reference
QCL source. This SSB is used at least to determine the QCL type D for
the target periodic CSI-RS.
freqBand
Is used to indicate to the CRBs occupied by CSI-RS below the UL
subband
freqBand_above
Is used to indicate to the CRBs occupied by CSI-RS above the UL
subband

Table 6 shows gNB-to-gNB-CLI-RS field descriptions. In case of measuring inter-subband interference from the aggressor gNB to the UL reception at the victim gNB, as shown in FIG. 13 when the aggressor gNB belongs to another operator or in FIG. 14 when the aggressor gNB belongs to the same operator, measuring RSRP may not be beneficial. That is, the victim gNB should descramble the RS and measure power, but such a power does not reflect the received power in the UL subband of the victim gNB. Therefore, the victim gNB may measure reference signal strength indicator (RSSI), i.e., total received power to reflect the leakage inter-subband interference from the aggressor gNB.

When the aggressor gNB belongs to the same operator and operates in legacy TDD operation mode or with different UL subband configurations, there is additional intra-subband interference, e.g., the interference caused by the DL transmission from the aggressor on the same frequency resources (e.g., RBs) used for UL subband at the victim gNB. In this case, the victim gNB experiences both inter-subband interference and intra-subband interference. This may be handled in some implementations. Specifically, at time “t1”, the aggressor gNB transmits CSI-RS only over the set of RBs that overlap with the UL subband of the victim gNB which in turn may measure RSRP to assess intra-subband interference. In time “t2”, the CSI-RS of the aggressor gNB may be transmitted in the set of RBs that does not overlap with the UL subband of the victim gNB. In this case, the victim gNB may measure RSSI/total power in the UL subband. Based on measurements in “t1” and “t2”, the victim gNB may reach a decision whether the beam is causing too much interference.

Alternatively, from the beginning, the victim gNB may simply perform RSSI measurements to capture the impact of inter-subband interference and intra-subband interference.

Steps 3 and 4 of FIG. 12 relate to measurements and subsequent action. The victim gNB may perform measurements based on L1-RSRP/SINR/RSSI/total power or any other metric for different SSB or CSI-RS from the aggressor gNB and report such quantities to the aggressor gNB. These reports may be provided to OAM which in turn forwards them to the aggressor gNB. Alternatively, the victim gNB may send such reports to the aggressor gNB using backhaul signaling over an Xn interface for example. Also, similar to UE periodic reporting, the aggressor gNB may provide the victim gNB the necessary configurations to provide such a report.

Rather than reporting L1-RSRP/SINR/RSSI/total power or any other metric for each measured SSB or CSI-RS from the aggressor gNB (which may significantly increase the reporting payload size), a simple indication from the aggressor gNB may be enough to indicate whether this DL beam from the aggressor gNB causes much interference or not.

As one possibility a single bit report for each beam or some beams (e.g., SSB or CSI-RS from the aggressor gNB) may be enough to indicate whether the DL beam is preferred by the victim gNB or not. If it is not preferred (or “nonpreferred”), the aggressor gNB is expected to refrain from using this DL beam especially when its DL transmission partially or fully overlaps in the time domain or in the frequency domain with the UL reception at the victim gNB.

Additional information may be provided to the aggressor gNB. For example, two or more bits, for each beam or some beams (e.g., SSB or CSI-RS from the aggressor gNB), may be reported. Table 7 (which illustrates providing additional information to the aggressor gNB for each beam (only 3 code points are used)) and Table 8 (which illustrates providing additional information to the aggressor gNB for each beam (only 4 code points are used)) exemplify how such additional information (which may be referred to as a degree of preferability or non-preferability of a beam associated with the reference signal) may be provided.

TABLE 7

| Code point | The corresponding interpretation |
|---|---|
| 00 | Not preferred |
| 01 | Neutral |
| 10 | Preferred |
| 11 | Reserved |

TABLE 8

| Code point | The corresponding interpretation |
|---|---|
| 00 | Not preferred |
| 01 | Slightly not preferred |
| 10 | Slightly preferred |
| 11 | Preferred |

UE-assistance to mitigate gNB-to-gNB CLI may be implemented, e.g., by defining unavailable resources for UL transmission, or by changing the UL or DL beam to mitigate gNB-to-gNB CLI. Defining unavailable resources for UL transmission may be performed as follows. To enable the victim gNB to measure the received interference from the aggressor gNB, it is beneficial to ensure UEs served by the victim gNB refrain from transmitting UL on the same resources used by the RS transmitted by the aggressor gNB for this purpose. Though this may be handled by the victim gNB for dynamic UL scheduling, it is challenging to be avoided for configured UL transmissions. Even for dynamic UL scheduling, completely avoiding such collisions may lead to inefficient scheduling.

As one possibility, the victim gNB may provide its UEs with the configurations of the RS transmitted by the aggressor gNB. Therefore, the UE may assume that the REs occupied by such RS are not available for UL transmission. The UE may either puncture or rate match around those REs. The victim gNB may provide the CSI-RS resource set to the UE and indicate that the REs spanned by CSI-RS in this resource set are used for conducting gNG-to-gNB CLI measurement and the UE should not transmit UL on those REs. For example, an RRC parameter such as availability may be used.

Instead of puncturing or rate matching around the REs occupied by the RS transmitted by the aggressor gNB, the UE may puncture or rate match around any RB that partially or fully overlaps with this RS. This procedure (in which the victim gNB provides its UEs with the configurations of reference signals transmitted by the aggressor gNB and the UEs rate match or puncture around the RBs/REs occupied by these reference signals) may work when the RS transmitted by the aggressor gNB overlap with UL subband of the victim gNB in both time domain and frequency domain, e.g., when both gNBs belong to the same operator and the victim gNB uses full-duplex operation while the aggressor gNB deploys a legacy TDD system as shown in FIG. 13 (intra subband interference). However, the RS transmitted by the aggressor gNB may only overlap with UL subband in time domain and the victim gNB may measure the leakage in the UL subband. This may occur when the aggressor gNB belongs to another operator or when both gNBs use full-duplex operation mode as shown in FIG. 13 and FIG. 14, respectively. In this case, the victim gNB may choose particular REs/RBs to conduct the measurements based on RSSI or total received power, for example.

To this end, the legacy rate matching used for PDSCH may be extended to be applied for UL transmission as well. Specifically, the same rateMatchPatternToAddModList, rateMatchPatternGroup1 and rateMatchPatternGroup2 provided for PDSCH may be applied for UL transmission. The UE may reinterpret the RRC parameter resourceBlocks which in legacy NR provides a resource block level bitmap in the frequency domain. A bit in the bitmap set to 1 indicates that the UE shall apply rate matching in the corresponding resource block in accordance with the symbolslnResourceBlock bitmap. If used as a cell-level rate matching pattern, the bitmap identifies “common resource blocks (CRB)”. If used as BWP-level rate matching pattern, the bitmap identifies “physical resource blocks” inside the UL BWP.

Therefore, for cell-level rate matching patterns, resourceBlocks may be directly applied as it is defined relative to CRB which should be the same for DL and UL in TDD operation. On the other hand, for BWP-level rate matching patterns, the UE may interpret resourceBlocks relative to UL subband or UL BWP which depends on the start and size of the UL subband or UL BWP, respectively. The symbolslnResourceBlock for DL PDSCH may be applied for the UL subband to specify in which symbols the UE should perform rate matching for UL transmission.

To provide the gNB with more flexibility and decouple the rate matching patterns for DL and UL, the rate patching pattern may include a separate bitmap for UL BWP from the bitmap used for downlink. This is exemplified by Listing 2.

Listing 2

-- ASN1START
-- TAG-RATEMATCHPATTERN-START

| | |
|---|---|
| RateMatchPattern ::= | SEQUENCE { |
| rateMatchPatternId | RateMatchPatternId, |
| patternType | CHOICE { |
| bitmaps | SEQUENCE { |
| resourceBlocks | BIT STRING (SIZE |
| (275)), | |
| symbolsInResourceBlock | CHOICE { |
| oneSlot | BIT STRING |
| (SIZE (14)), | |
| twoSlots | BIT STRING |
| (SIZE (28)) | |
| }, | |
| periodicityAndPattern | CHOICE { |
| n2 | BIT STRING |
| (SIZE (2)), | |
| n4 | BIT STRING |
| (SIZE (4)), | |
| n5 | BIT STRING |
| (SIZE (5)), | |
| n8 | BIT STRING |
| (SIZE (8)), | |
| n10 | BIT STRING |
| (SIZE (10)), | |
| n20 | BIT STRING |
| (SIZE (20)), | |
| n40 | BIT STRING |
| (SIZE (40)) | |

```
        }
OPTIONAL, -- Need S
        ...
```

| | |
|---|---|
| }, | |
| controlResourceSet | ControlResourceSetId |
| }, | |
| Bitmaps-UL | SEQUENCE { |
| resourceBlocks-UL | BIT STRING |
| (SIZE (275)), | |
| symbolsInResourceBlock-UL | CHOICE { |
| oneSlot | BIT STRING |
| (SIZE (14)), | |
| twoSlots | BIT STRING |
| (SIZE (28)) | |
| }, | |
| periodicityAndPattern-UL | CHOICE { |
| n2 | BIT STRING |
| (SIZE (2)), | |
| n4 | BIT STRING |
| (SIZE (4)), | |
| n5 | BIT STRING |
| (SIZE (5)), | |
| n8 | BIT STRING |
| (SIZE (8)), | |
| n10 | BIT STRING |
| (SIZE (10)), | |
| n20 | BIT STRING |
| (SIZE (20)), | |
| n40 | BIT STRING |
| (SIZE (40)) | |
| } | |
| OPTIONAL, -- Need S | |
| } | |
| subcarrierSpacing | SubcarrierSpacing |
| OPTIONAL, -- Cond CellLevel | |
| subcarrierSpacing-UL | SubcarrierSpacing |
| OPTIONAL, -- Cond CellLevel | |
| dummy | ENUMERATED { |
| semiStatic }, | dynamic, |
| ..., | |
| [[ | |
| controlResourceSet-r16 | ControlResourceSetId- |
| r16 | OPTIONAL -- Need |
| R | |
| ]] | |
| } | |

-- TAG-RATEMATCHPATTERN-STOP

-- ASN1STOP

TABLE 9
RateMatchPattern field descriptions

Undefined parameters follow the legacy definitions.
Bitmaps-UL
Indicates UL rate matching pattern by a pair of bitmaps resourceBlocks and
symbolsInResourceBlock to define the rate match pattern within one or two slots,
and a third bitmap periodicityAndPattern to define the repetition pattern with which
the pattern defined by the above bitmap pair occurs.
periodicityAndPattern-UL
A time domain UL repetition pattern at which the pattern defined by
symbolsInResourceBlock and resourceBlocks recurs. This slot pattern repeats
itself continuously. Absence of this field indicates the value n1.
resourceBlocks-UL
A UL resource block level bitmap in the frequency domain. A bit in the bitmap set
to 1 indicates that the UE shall apply rate matching in the corresponding resource
block in accordance with the symbolsinResourceBlock bitmap. If used as cell-level
rate matching pattern, the bitmap identifies “common resource blocks (CRB)”. If
used as BWP-level rate matching pattern, the bitmap identifies “physical resource
blocks” inside the BWP. The first/ leftmost bit corresponds to resource block 0, and
so on (see TS 38.214 [19], clause 5.1.4.1).
subcarrierSpacing-UL
The SubcarrierSpacing for this UL resource pattern. If the field is absent, the UE
applies the SCS of the associated BWP. The value KHz 15 corresponds to u = 0, the
value kHz 30 corresponds to u = 1, and so on.
Only the following values are applicable depending on the used frequency (see TS
38.214 [19], clause 5.1.4.1):
FR1: 15, 30 or 60 KHz
FR2-1: 60 or 120 KHz
FR2-2: 120, 480, or 960 kHz
symbolsInResourceBlock-UL
A UL symbol level bitmap in time domain. It indicates with a bit set to true that the
UE shall rate match around the corresponding symbol. This pattern recurs (in time
domain) with the configured periodicityAndPattern.
For oneSlot, if ECP is configured, the first 12 bits represent the symbols within the
slot and the last two bits within the bitstring are ignored by the UE; Otherwise, the
14 bits represent the symbols within the slot.
For twoSlots, if ECP is configured, the first 12 bits represent the symbols within the
first slot and the next 12 bits represent the symbols in the second slot and the last
four bits within the bit string are ignored by the UE; Otherwise, the first 14 bits
represent the symbols within the first slot and the next 14 bits represent the
symbols in the second slot.
For the bits representing symbols in a slot, the most significant bit of the bit string
represents the first symbol in the slot and the second most significant bit
represents the second symbol in the slot and so on.

Table 9 shows RateMatchPatterm field descriptions. Alternatively, a new set of RRC IEs rateMatchPatternToAddModList, rateMatchPatternGroup1 and rateMatchPatternGroup2 may be provided as part of PUSCH-Config or in ServingCellConfig or ServingCellConfigCommon with suffix “UL”. The same procedures for PDSCH may be extended to be applied for PUSCH as well. The UL scheduling DCIs, e.g., DCI format 0_1 or DCI format 0_2, may have new fields to indicate which rate matching group is to be applied.

Although the bitmaps for indicating the unavailable resources in the time domain and frequency domain in UL subband and the corresponding periodicity are part of UL rate matching configurations, they may be provided to the UE separate from rate matching configurations.

Also, the victim gNB may indicate to its UEs the unavailable resources in RE level similar to the zero-power-CSI-RS (ZP-CSI-RS) procedures for DL. In legacy NR, indicating the unavailable REs uses the same framework as indicating the time domain and frequency domain location of NZP-CSI-RS. Specifically, CSI-RS-ResourceMapping and CSI-ResourcePeriodicityAndOffset are used to define the RE mapping of ZP-CSI-RS and the corresponding periodicity/offset for the periodic and semi-persistent ZP-CSI-RS, respectively. Therefore, PUSCH-Config may include the RRC parameters for aperiodic, semi-persistent and periodic ZP-CSI-RS. The UL scheduling DCIs, e.g., DCI format 0_1 or DCI format 0_2, may have new fields to indicate which aperiodic ZP-CSI-RS resource is to be applied.

Regarding the time location of ZP-CSI-RS used for PUSCH, the UE may follow the legacy NR to determine the time domain location. For the frequency domain location of ZP-CSI-RS, the UE may interpret freqBand in CSI-RS-ResourceMapping relative to the UL subband depending on how it is defined, i.e., either as subband or UL BWP, or directly relative to UL BWP.

Since the bandwidth of the UL subband is expected to be small, it may not be necessary for nrofRBs indicating the number of PRBs spanned by ZP-CSI-RS for PUSCH to be a multiple of 4. For example, it may instead be with the granularity of a single RB. Also, it may not be necessary for the ZP-CSI-RS to occupy contiguous RBs in the UL subband or UL BWP. Therefore, a bitmap may be used to indicate which RBs in the UL subband or UL BWP are occupied by ZP-CSI-RS for PUSCH. Each bit may be mapped to a single RB or multiple RBs depending on the size of the UL subband. The gNB may indicate to the UE how to interpret each bit and determine its resolution.

Also, it may not be necessary for the number of RBs spanned by ZP-CSI-RS for PUSCH to be greater than min (24, the size of UL subband or UL BWP). Such a condition may be relaxed depending on how many resources the victim gNB intends to use to conduct the measurements. The UE may indicate to the gNB whether it supports any of the aforementioned procedures via UE capability signaling, for example. The UE may indicate such a capability with even finer granularity depending on the nature of the UL transmission. For example, rate matching or puncturing may be applied for a periodic or semi-persistent UL transmission, but not for a dynamic UL transmission. This enables the UE to have enough time and early knowledge whether puncture or rate matching for UL transmission is to take place. Also, for UL rate matching patterns, the UE may indicate that it only supports the RRC configured rate patterns, not the dynamically indicated ones. Similarly, for ZP-CSI-RS for PUSCH, the UE may indicate that only periodic or semi-persistent ZP-CSI-RS for PUSCH is supported, but not aperiodic ZP-CSI-RS for PUSCH.

Also, to further simplify the UE implementation, when the UL transmission fully or partially overlaps with RS used for gNB-to-gNB CLI, resources indicated by rate matching patterns for UL or resources indicated by ZP-CSI-RS for UL, the UE may fully or partially cancel the UL transmission. For example, there may be a particular timeline or capability similar to the cancellation timeline or capability in case of conflict between RRC UL transmission and dynamic DL reception in the context of TDD slot configurations.

Changing UL/DL beam to mitigate gNB-to-gNB CLI may be performed as follows. When the victim gNB experiences interference from the aggressor gNB, it may be beneficial that UL transmission from the UE served by the victim gNB uses a different UL beam than the one used when there is no such interference. Conversely, when the aggressor gNB causes interference to the victim gNB, it may be beneficial that the DL transmission to the UE served by the aggressor gNB uses a different DL beam than the one used when there is no such interference.

This may be handled by gNB implementation for dynamic DL and UL scheduling. However, for configured DL (such as SPS), UL (configured grant type 1 and 2), or dynamic UL/DL with multiple repetitions, it may be challenging to change the DL beam or UL beam, respectively, based on whether the interference exists or not.

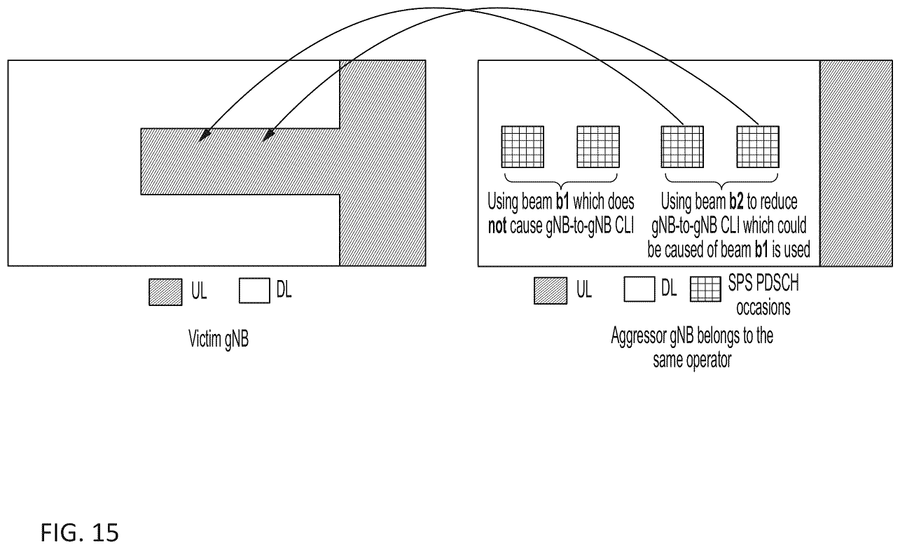

FIG. 15 shows an example for SPS transmission by the aggressor gNB where the first and second PDSCH occasions do not overlap with the UL subband at the victim gNB. On the other hand, the third and fourth occasions overlap with the UL subband and cause interference. In this case, it is beneficial to use a transmit beam for the first pair of PDSCH occasions (beam b1) that differs from the transmit beam for the second pair of PDSCH occasions (beam b2). Here, beam b2 is selected such that it results in less gNB-to-gNB CLI. The same concept may be extended to dynamic PDSCH with repetitions where the applicable beam may be determined based on the overlapping with UL subband.

In terms of indication, within the activation the DCI may provide the TCI code point associated with two TCI states. The first one may be one that is to be used in PDSCH occasions that do not overlap with UL subband of the victim gNB. The second one may be one that is to be used in PDSCH occasions that overlap with UL subband of the victim gNB. As one possibility, the aggressor gNB may provide its UE with UL subband configurations of the victim gNB. Therefore, the UE may infer which transmit beam the aggressor gNB intends to use. Similar to the activation DCI of SPS PDSCH, the DCI of dynamic PDSCH with repetition may apply the same concept to indicate the applicable TCI state for each PDSCH repetition.

Alternatively, the aggressor gNB may provide its UE with a duration (time window) and possibly the period in which the second indicated beam in the activation DCI is assumed for the reception of a SPS PDSCH occasion or dynamic PDSCH repetition. Outside this duration (time window), the first indicated beam is assumed. Also, the aggressor gNB may use a bitmap to indicate the time domain resources in which the first or second beam is to be applied. Each bit may correspond to an OFDM symbol, slot, SPS PDSCH occasion, etc. If the PDSCH occasion is indicated as part of the time interval during which the first beam is used, the UE uses the first beam for the reception, and if the PDSCH occasion is indicated as part of the time interval during which the second beam is used, the UE uses the second beam for the reception.

Also, based on some predefined rules, i.e., provided in the specs, the UE may determine whether the first or second indicated beam is used for transmitting a PDSCH occasion. Such a rule may be a function of the time location of PDSCH occasion, its duration, etc.

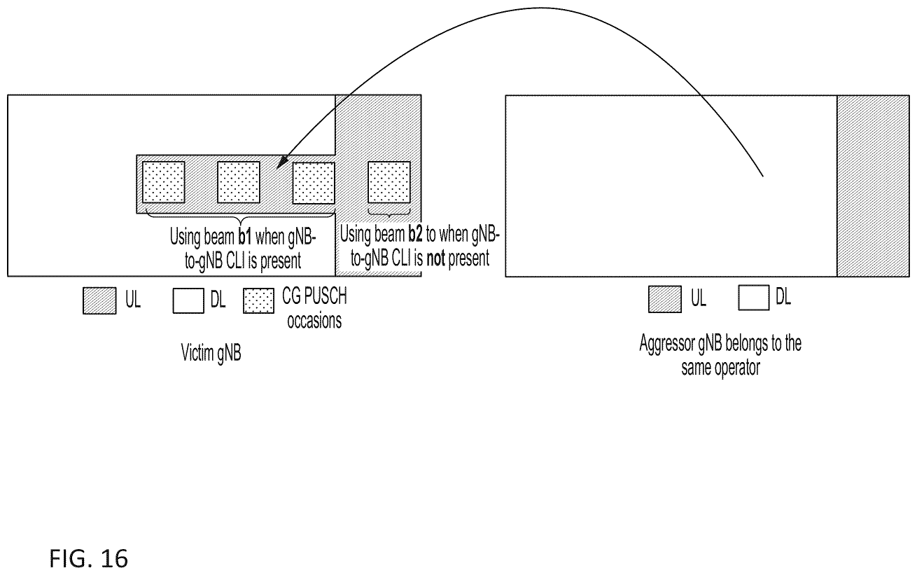

Although the aforementioned solution is described for SPS, a similar idea may be extended to CG PUSCH as shown in FIG. 16. If the UE decides to use CG PUSCH occasions that fall within UL subband, the UE may use beam b1. For CG PUSCH occasions that fall within regular UL BWP, the UE may use another beam as it will not suffer from gNB-to-gNB CLI. For CG PUSCH type 1, additional srs-ResoruceIndicator-2 may be configured by higher layer signaling. For example, the legacy srs-ResoruceIndicator is used to indicate the beam for CG PUSCH in UL subband while srs-ResoruceIndicator-2 indicates beam for CG PUSCH in regular UL BWP. For CG PUSCH type 2, two SRIs fields may be included in the activation DCI to realize the same goal. The same concept may be applied for dynamic PUSCH with repetition and the scheduling DCI of dynamic PUSCH with repetitions may be similar to the CG activation DCI.

The UE may determine which CG PUSCH occasion or dynamic PDSCH repetition overlaps with UL subband and which overlaps with regular UL BWP, if the UE is aware of UL subband. If not, any of the aforementioned solutions for SPS may be applied.

Although certain solutions are described herein for SPS and CG, for dynamic PDSCH or dynamic PUSCH, the gNB may provide the UE with multiple optional beams for the reception or the transmission, respectively, using a similar approach. The UE may select one of the indicated beams based on gNB-to-gNB CLI or UE-to-UE CLI as described below.

Enhancements to enable UE-to-UE CLI may include the following. The aggressor UE is a UE transmitting an UL transmission that causes interference on the DL reception of another UE referred to as the victim UE. There are several approaches to enable UE-to-UE CLI measurement and mitigation. One possibility is to be based on R16 CLI measurements wherein the aggressor UE transmits SRS and the victim UE receives it to determine the interference strength and to report either RSRP or RSSI to its serving gNB. Another alternative approach is that the victim UE transmits SRS before receiving the DL transmission. The aggressor UE receives this SRS and assesses whether (i) it may transmit its UL, or (ii) it will cause excessive interference to the victim UE. In the latter case, the aggressor UE may do one or combination of the following:
(i) The aggressor UE may cancel its UL transmission if such assessment is made early enough. The UE may fully or partially cancel the UL transmission. For example, there may be a particular timeline or capability similar to the cancellation timeline or capability in case of conflict between RRC UL transmission and dynamic DL reception in the context of TDD slot configurations.
(ii) The aggressor UE may reduce its transmit power. The reduction amount may depend on the strength of the received SRS from the victim UE. For example, if the received signal strength of SRS is high (e.g., if the aggressor UE is close to the victim UE), the aggressor UE has to significantly reduce its transmit power. If the reduced power becomes very low, it may be beneficial to cancel the UL transmission because it is less likely that such a transmission may be successfully received by the gNB. The threshold value below which the UE cancels its UL transmission may be configured by the gNB.
(iii) Whether to cancel or reduce the power of the UL transmission of the aggressor UE may depend on the UL transmission priority. For a high priority UL transmission, the aggressor UE may not cancel or reduce the power of the intended UL transmission.
(iv) If multiple transmit beams are indicated to the aggressor UE, similar to the example in FIG. 16, the UE may choose the proper beam that corresponds to the lowest SRS power level.

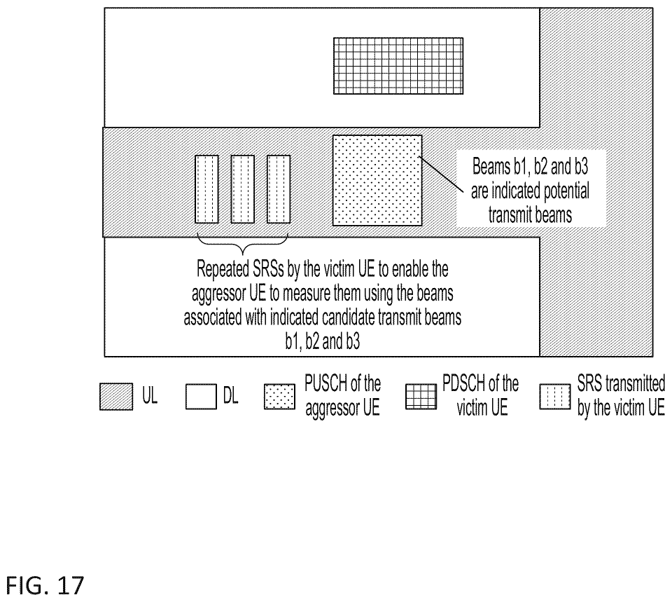

FIG. 17 shows an example in which the UL transmission of the aggressor UE is indicated to have multiple candidate transmit beams, b1, b2 and b3. In this case, the victim UE may transmit multiple SRS; the number of SRS occasions may be equal to number of indicated or configured beams for the aggressor UE. This may enable the aggressor UE to receive SRS with the beams reciprocal to the indicated or configured beams b1, b2 and b3. Based on the measurement of SRS, the aggressor UE may select the transmit beam for PUSCH that results in least interference to the victim UE.

This approach may also be applied for different DL channel reception at the victim UE that may be either semi-statically configured or dynamically scheduled. On the other hand, the aggressor UE may be provided with multiple candidate transmit beams for different UL channels that may either semi-statically configured or dynamically scheduled.

For any of the above approaches, based on R16 CLI or an approach in which the victim UE transmits SRS before its DL reception, it may be beneficial to determine which receive beam should be used for receiving SRS to obtain accurate measurements of UE-to-UE CLI.

In the former approach, the victim UE measures SRS from the aggressor UE. In this case, the victim UE may use the same beam to receive SRS as one indicated or configured for the reception of the latest DL transmission.

In the latter approach, the aggressor UE measures SRS from the victim UE. In this case, the aggressor UE may use the reciprocal beam to receive SRS to the indicated or configured transmit for the earliest UL transmission. If the aggressor UE is indicated or configured with multiple candidate transmit beams, the aggressor UE may use the reciprocal beam of each beam in the set of candidate beams in a particular order, e.g., based on the Id of the associated QCL source reference signal.

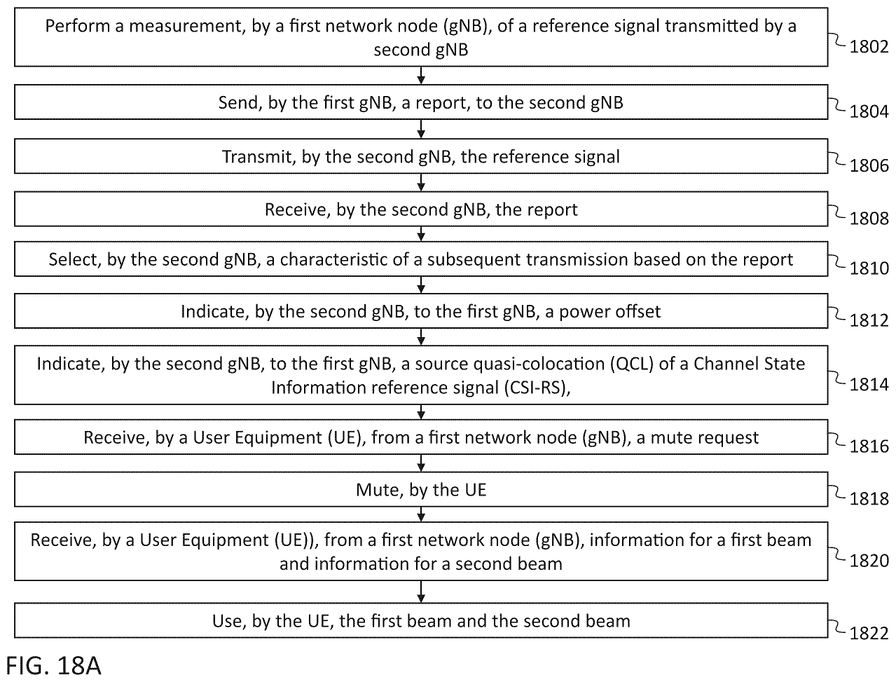

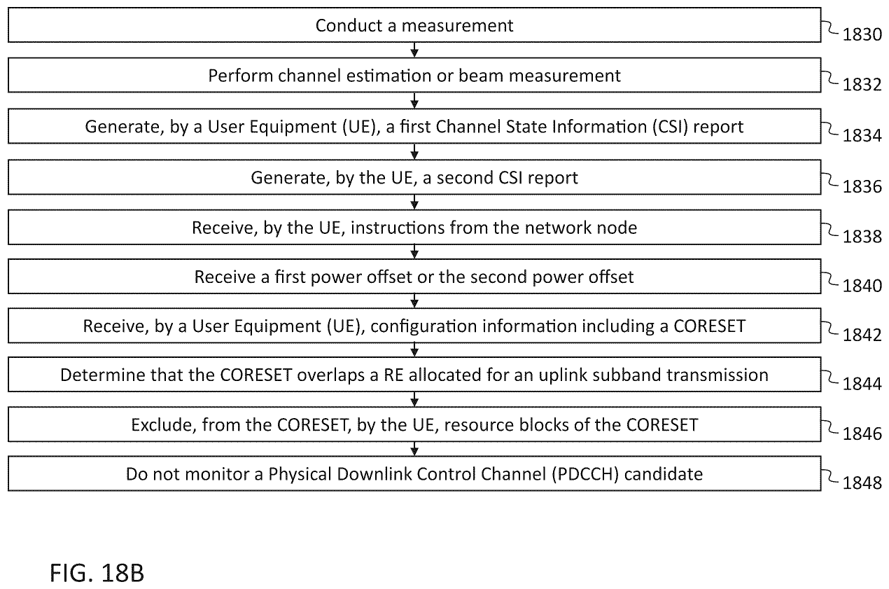

FIG. 18A is a flowchart of a method, in some embodiments. The method includes Performing, at 1802, a measurement, by a first network node (gNB), of a reference signal transmitted by a second gNB; and sending, at 1804, by the first gNB, a report, to the second gNB, the report being based on the measurement, the first gNB being capable of supporting full-duplex communications. The method further includes transmitting, at 1806, by the second gNB, the reference signal; receiving, at 1808, by the second, gNB, the report; and selecting, 1810, by the second gNB, a characteristic of a subsequent transmission based on the report. The method further includes indicating, at 1812, by the second gNB, to the first gNB, a power offset between a Channel State Information reference signal (CSI-RS) and a Synchronization Signal Block (SSB). The method further includes indicating, at 1814, by the second gNB, to the first gNB, a source quasi-colocation (QCL) of a Channel State Information reference signal (CSI-RS), the indicating of the source QCL comprising indicating an index of a Synchronization Signal Block (SSB) with which the CSI-RS is QCLed. The method further includes receiving, at 1816, by a User Equipment (UE), from a first network node (gNB), a mute request, the mute request identifying a resource element (RE); and muting, at 1818, by the UE, the RE. The method further includes receiving, at 1820, by a User Equipment (UE)), from a first network node (gNB), information for a first beam and information for a second beam; and using, by the UE, at 1822, the first beam during a first time interval, overlapping a full-duplex uplink subband; and using, by the UE, at 1822, the second beam during a second time interval, not overlapping a full-duplex uplink subband.

FIG. 18B is a flowchart of a method, in some embodiments. The method includes conducting, at 1830, a measurement, by a User Equipment (UE), during a CSI resource, the CSI resource being a Channel State Information reference signal (CSI-RS) or a Channel State Information Interference Measurement (CSI-IM); and performing, at 1832 channel estimation or beam measurement, by the UE, the channel estimation or beam measurement being based on a set of resources of the CSI resource, the resources of the set of resources being non-contiguous in a symbol of the CSI resource.

The method further includes generating, at 1834, by a User Equipment (UE), a first Channel State Information (CSI) report based on a first plurality of CSI resources, each of the first plurality of CSI resources being a Channel State Information reference signal (CSI-RS) or a Channel State Information Interference Measurement (CSI-IM); and generating, at 1836, by the UE, a second CSI report based on a second plurality of CSI resources, each of the second plurality of CSI resources being a Channel State Information reference signal (CSI-RS) or a Channel State Information Interference Measurement (CSI-IM), the second plurality of CSI resources being selected based on: instructions from a network node (gNB) or an overlap, in time, of an uplink subband with each of the CSI resources of the second plurality of CSI resources, or a change in a network antenna pattern between transmission of the first plurality of CSI resources and transmission of the second plurality of CSI resources.

The method further includes receiving, at 1838, by the UE, instructions from the network node, the instructions including an identification of a CSI resource of the first plurality of CSI resources. The method further includes receiving, at 1840, by the UE, from a network node (gNB) the first power offset or the second power offset as part of Radio Resource Control (RRC) configuration information. The method further includes receiving, at 1842, by a User Equipment (UE), configuration information including a Control Resource Set (CORESET) and a first monitoring occasion; and determining, at 1844, by the UE, that in the first monitoring occasion, the CORESET overlaps a resource element (RE) allocated for an uplink subband transmission. The method further includes excluding, at 1846, from the CORESET, by the UE, each resource block of the CORESET overlapping a resource element (RE) allocated for an uplink subband transmission. The method further includes not monitoring, at 1848, by the UE, a Physical Downlink Control Channel (PDCCH) candidate overlapping a resource element allocated for the uplink subband transmission.

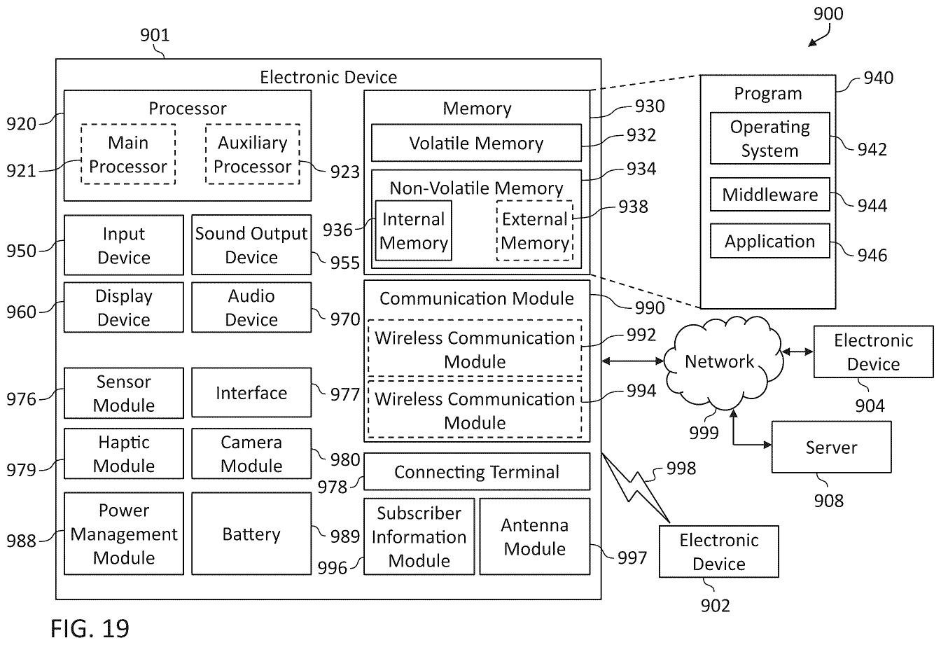

FIG. 19 is a block diagram of an electronic device 901 (e.g., a UE) in a network environment 900, according to an embodiment. Such an electronic device 901 may perform one or more of the methods disclosed herein.

Referring to FIG. 19, an electronic device 901 in a network environment 900 may communicate with an electronic device 902 via a first network 998 (e.g., a short-range wireless communication network), or an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 940, a sound output device 955, a display device 960, an audio module 970, a sensor module 976, an interface 977, a haptic module 979, a camera module 980, a power management module 988, a battery 989, a communication module 990, a subscriber identification module (SIM) card 996, or an antenna module 994. In one embodiment, at least one (e.g., the display device 960 or the camera module 980) of the components may be omitted from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

The processor 920 may execute software (e.g., a program 940) to control at least one other component (e.g., a hardware or a software component) of the electronic device 901 coupled with the processor 920 and may perform various data processing or computations.

As at least part of the data processing or computations, the processor 920 may load a command or data received from another component (e.g., the sensor module 946 or the communication module 990) in volatile memory 932, process the command or the data stored in the volatile memory 932, and store resulting data in non-volatile memory 934. The processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. The display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. The audio module 970 may obtain the sound via the input device 950 or output the sound via the sound output device 955 or a headphone of an external electronic device 902 directly (e.g., wired) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which the electronic device 901 may be physically connected with the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the AP) and supports a direct (e.g., wired) communication or a wireless communication. The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as Bluetooth™, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

Commands or data may be transmitted or received between the electronic device 901 and the external electronic device 904 via the server 908 coupled with the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous. As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
conducting a measurement, by a User Equipment (UE), using a CSI resource, the CSI resource being a Channel State Information reference signal (CSI-RS) or a Channel State Information Interference Measurement (CSI-IM); and
performing channel estimation or beam measurement, by the UE, the channel estimation or beam measurement being based on a set of resources of the CSI resource, the resources of the set of resources being non-contiguous in a symbol of the CSI resource.

2. The method of claim 1, wherein the performing of channel estimation or beam measurement, by the UE, comprises selecting the set of resources based on resources allocated for full-duplex uplink subband.

3. The method of claim 2, wherein:
a first portion of a resource block set (RB set) of the CSI resource overlaps one or more resource elements allocated for full-duplex uplink subband;
a second portion of the RB set does not overlap any resource elements allocated for full-duplex uplink subband; and
the set of resources does not include any resources of the RB set.

4. The method of claim 2, wherein:
a first portion of a resource block set (RB set) of the CSI resource overlaps one or more resource elements allocated for full-duplex uplink subband;
a second portion of the RB set does not overlap any resource elements allocated for full-duplex uplink subband; and
the set of resources includes the second portion of the RB set, and does not include the first portion of the RB set.

5. The method of claim 2, wherein:
a first portion of a CSI subband of the CSI resource overlaps one or more resource elements allocated for full-duplex uplink subband;
a second portion of the CSI subband of the CSI resource does not overlap any resource elements allocated for full-duplex uplink subband; and
the CSI subband of the CSI resource excludes the first portion of the CSI subband of the CSI resource and consists of only the second portion.

6. The method of claim 2, wherein the UE expects that for each indicated CSI subband to be reported, the CSI-RS linked to the report is at least mapped to the resource blocks (RBs) spanned by the CSI subband.

7. The method of claim 1, wherein:
the set of resources comprises a first portion and a second portion, the second portion being non-contiguous with the first portion; and
the method further comprises receiving, by the UE, configuration information from a network node (gNB) identifying the first portion of the set of resources and the second portion of the set of resources.

8. The method of claim 1, wherein:
the set of resources comprises a first portion and a second portion, the second portion being non-contiguous with the first portion; and
the method further comprises determining, by the UE, the first portion of the set of resources and the second portion of the set of resources.

9. The method of claim 1, wherein:
the set of resources comprises a first portion and a second portion, the second portion being non-contiguous with the first portion; and
the minimum number of allocated resource elements of the non-contiguous set of resources of the CSI resource in each portion is expected to be greater than a certain threshold.

10. A method, comprising:
generating, by a User Equipment (UE), a first Channel State Information (CSI) report based on a first plurality of CSI resources, each of the first plurality of CSI resources being a Channel State Information reference signal (CSI-RS) or a Channel State Information Interference Measurement (CSI-IM); and
generating, by the UE, a second CSI report based on a second plurality of CSI resources, each of the second plurality of CSI resources being a Channel State Information reference signal (CSI-RS) or a Channel State Information Interference Measurement (CSI-IM),
the second plurality of CSI resources being selected based on:
instructions from a network node (gNB) or
an overlap, in time, of a full-duplex uplink subband with each of the CSI resources of the second plurality of CSI resources, or
a change in a network antenna pattern or power pattern between transmission of the first plurality of CSI resources and transmission of the second plurality of CSI resources.

11. The method of claim 10, further comprising receiving, by the UE, instructions from the network node, the instructions including an identification of a CSI resource of the first plurality of CSI resources or an identification of a CSI resource of the second plurality of CSI resources.

12. The method of claim 11, further comprising receiving, by the UE, the identification in the form of a Radio Resource Control (RRC) parameter or a MAC-CE.

13. The method of claim 10, wherein the second CSI report is a differential report with respect to the first CSI report.

14. The method of claim 10, wherein:
the generating of the first CSI report comprises generating the first CSI report based on a first power offset; and
the generating of the second CSI report comprises generating the second CSI report based on a second power offset, different from the first power offset.

15. The method of claim 14, further comprising receiving, by the UE, from a network node (gNB) the first power offset or the second power offset as part of Radio Resource Control (RRC) configuration information.

16. The method of claim 15, further comprising:
receiving, by the UE, from the gNB, a third power offset as part of Radio Resource Control (RRC) configuration information; and
using the first power offset or the second power offset to override or to modify, by the UE, the third power offset.

17. The method of claim 10, wherein:
the first CSI report is based on a first plurality of subcarriers within each the first plurality of CSI resources; and
the second CSI report is based on a second plurality of subcarriers, different from the first plurality of subcarriers, within each the second plurality of CSI resources.

18. A method, comprising:
receiving, by a User Equipment (UE), configuration information including a Control Resource Set (CORESET) and a first monitoring occasion; and
determining, by the UE, that in the first monitoring occasion, the CORESET overlaps a resource element (RE) allocated for a full-duplex uplink subband.

19. The method of claim 18, further comprising excluding from the CORESET, by the UE, each resource block of the CORESET overlapping a resource element (RE) allocated for a full-duplex uplink subband.

20. The method of claim 18, further comprising not monitoring, by the UE, a Physical Downlink Control Channel (PDCCH) candidate overlapping a resource element allocated for the full-duplex uplink subband.
